(19) United States
(12) Patent Application Publication
(10) Pub. No.: US 2024/0275823 A1
(43) Pub. Date: Aug. 15, 2024

(54) VIRTUALIZED CONTROLLERS FOR IN-VEHICLE AND IOT NETWORKS

(71) Applicant: Karamba Security Ltd., Hod Hasharon (IL)

(72) Inventors: Assaf Harel, Ramat Hasharon (IL); Amiram Dotan, Birmingham, MI (US); Tal Efraim Ben David, Hogla (IL); David Barzilai, Hod Hasharon (IL); Eli Mordechai, Modiin (IL)

(21) Appl. No.: 18/643,940

(22) Filed: Apr. 23, 2024

Related U.S. Application Data
(63) Continuation of application No. 17/271,332, filed on Feb. 25, 2021, now abandoned.
(60) Provisional application No. 62/724,987, filed on Aug. 30, 2018.

(51) Int. Cl. H04L 9/40; G06F 9/455; G06F 21/53; H04L 9/08; H04L 67/12

(52) U.S. Cl. CPC H04L 63/205; G06F 9/45558; G06F 21/53; H04L 9/0894; H04L 63/0428; H04L 67/12; G06F 2009/4557; H04L 63/14

(57) ABSTRACT

Disclosed herein are techniques for protecting a plurality of ECUs within a vehicle or other IoT system. Techniques include instantiating a plurality of virtual computing instances in a vehicle computing network within the vehicle, each of the plurality of virtual computing instances being configured to perform at least one vehicle software function; and identifying, for the plurality of virtual computing instances, a corresponding set of security rules configured to maintain security of each of the plurality of virtual computing instances, such that the at least one common hardware processor provides security to the plurality of virtualized computing instances.

### CROSS-REFERENCE TO RELATED APPLICATIONS

This application claims priority to U.S. Provisional Patent App. No. 62/724,987, filed on Aug. 30, 2018, which is incorporated herein by reference in its entirety.

### TECHNICAL FIELD

The subject matter described herein generally relates to protecting vehicle software and systems, as well as various other types of Internet-of-Things (IoT) or network-connected systems, that utilize controllers such as electronic control units (ECUs) or other controllers. For example, certain disclosed embodiments are directed to systems for providing security to ECUs or other controllers through a virtualized environment. These techniques may include developing and deploying specialized security rules for controllers in a virtualized vehicle or other IoT environment. These techniques may also protect controllers against malicious applications based on results detected from running applications in a virtualized or sandboxed environment. In some cases, the techniques may further allow controllers to access unique cryptographic keys for use in securely exchanging encrypted messages among controllers.

### BACKGROUND

Modern vehicles can contain numerous electronic control units (ECUs), which may be responsible for controlling a variety of vehicle functions ranging from core automotive functions such as steering, braking, and acceleration, to other functions such as entertainment, network-connectivity, social media, e-commerce, and more. Likewise, many Internet-of-Things (IoT) systems include numerous network-accessible controllers, such as home security systems, parking garage sensor systems, inventory monitoring systems, connected appliances, telephony equipment, network routing devices, smart power grid systems, drones or other unmanned vehicles, and many more. Because many of these controllers are directly or indirectly connected to the Internet, they are vulnerable to cyberattacks, malicious file downloads, corrupt or error-causing files, and other malware.

Conventional software security techniques that may be implemented in enterprises or on personal computers do not translate well to vehicle environments and other IoT environments. These techniques often assume large, if not unlimited, amounts of computing storage space and processing power. If these techniques were to be attempted in most vehicle or IoT environments, they would consume too much of the storage and processing abilities of controllers, and consequently would either cause the controllers to slow or fail, or would simply not be capable of implementation. Accordingly, software security techniques for vehicles and IoT devices are often constrained by the stringent memory and processing limitations of controllers.

Moreover, conventional systems do not have adequate techniques for determining potential threats posed by downloaded applications. For example, in modern vehicles users are able to download applications, files, and data through interfaces such as infotainment systems and through mobile devices that connect to their vehicles. Without sufficient safeguards in place, these attack surfaces leave vehicles open to downloads of malicious software, which can surreptitiously gather user data, corrupt vehicle software, or even take control of vehicle functions and threaten occupant safety. These vulnerabilities can also lead to bothersome vehicle recalls, which may occupy the time and resources of consumers and manufacturers.

Current systems also have no reliable and secure way of providing cryptographic key access to controllers for use in exchanging encrypted communications among controllers. By giving controllers fixed identifiers to use for accessing a key table, current systems risk repeated use of the same “unique” identifier, which can threaten vehicle or IoT system security. Moreover, using provisioning techniques to ensure that controllers are given different unique identifiers can strain other resources that could be used for other tasks.

In view of the technical deficiencies of current systems, there is a need for improved systems and methods for providing comprehensive security protections for controllers. The techniques discussed below offer many technological improvements in security, efficiency, and usability. For example, according to some techniques, vehicle or IoT system controllers may operate in a virtualized framework, where individual controllers may be deployed as virtual machines, container instances, or other virtualized computing resources. In this manner, as operations or environments change, controllers may be spun up and spun down dynamically, on an as-needed basis, to efficiently meet the changing needs of the vehicle or IoT system.

Further, some disclosed techniques allow for externally originating software to be scrutinized in a virtual or sandbox environment. This environment, which may mimic or replicate the vehicle's or IoT system's actual network, may be used to reveal whether the downloaded software is malicious or benign. For example, a social media application that is downloaded may be considered malicious if it attempts to control vehicle steering or windshield wipers. Additional technical improvements relate to maintaining secure key tables that store cryptographic keys used for encrypting controller communications. Access to the key table may be conditioned on particular controllers presenting a decryption key based on a unique processor (e.g., microprocessor) identifier associated with the controllers' processors. Further techniques include incorporating security agents or software within cables (e.g., within a connector or interface) in order to securely encrypt and decrypt communications being exchanged along the cable. Additional techniques relate to improved two-factor authentication for IoT controller communications. These and other techniques for protecting vehicle and IoT environments in a reliable and efficient manner are described below.

### SUMMARY

Some disclosed embodiments describe non-transitory computer readable media, systems, and methods protecting a plurality of ECUs within a vehicle. For example, in an exemplary embodiment, there may be a virtualized system for protecting a plurality of ECUs within a vehicle, the system comprising at least one common hardware processor configured to emulate a plurality of ECUs for multiple components of the vehicle, and a set of instructions executable by the at least one hardware processor to perform operations. The operations may comprise instantiating a plurality of virtual computing instances in a vehicle computing network within the vehicle, each of the plurality of virtual computing instances being configured to perform at least one vehicle software function; and identifying, for the plurality of virtual computing instances, a corresponding set of security rules configured to maintain security of each of the plurality of virtual computing instances, such that the at least one common hardware processor provides security to the plurality of virtualized computing instances.

In accordance with further embodiments, the plurality of virtual computing instances are virtual machines.

In accordance with further embodiments, the plurality of virtual computing instances are container resources.

In accordance with further embodiments, the plurality of virtual computing instances are configured to be spun up, on demand, to perform the at least one vehicle software function.

In accordance with further embodiments, the set of security rules is configured to enforce one or more deterministic security attributes of the plurality of virtual computing instances.

In accordance with further embodiments, the one or more deterministic security attributes are developed through static analysis of code to be executed by the plurality of virtual computing instances.

In accordance with further embodiments, the one or more deterministic security attributes are developed through dynamic analysis of code to be executed by the plurality of virtual computing instances.

In accordance with further embodiments, the operations further comprise deploying the plurality of virtual computing instances together with the corresponding set of security rules in the vehicle computing network.

In accordance with further embodiments, the operations further comprise monitoring functionality of the plurality of virtual computing instances during live operations in the vehicle computing network.

In accordance with further embodiments, the operations further comprise identifying, based on the monitored functionality, potential deviations from the corresponding set of security rules.

In accordance with further embodiments, the operations further comprise performing, based on the identified potential deviations, control actions preventing the plurality of virtual computing instances from experiencing the potential deviations.

In accordance with further embodiments, the operations further comprise modifying, based on the identified potential deviations, the corresponding set of security rules.

In accordance with further embodiments, the operations further comprise determining whether the identified potential deviations relate to a predefined sensitive vehicle software function.

Further disclosed embodiments include a method, performed in a virtualized system within a vehicle, for protecting a plurality of ECUs within the vehicle. The method may comprise instantiating a plurality of virtual computing instances in a vehicle computing network within the vehicle, each of the plurality of virtual computing instances being configured to perform at least one vehicle software function; and identifying, for the plurality of virtual computing instances, a corresponding set of security rules configured to maintain security of each of the plurality of virtual computing instances, such that the at least one common hardware processor provides security to the plurality of virtualized computing instances.

In accordance with further embodiments, the set of security rules is configured to enforce one or more deterministic security attributes of the plurality of virtual computing instances.

In accordance with further embodiments, the one or more deterministic security attributes are developed through static analysis of code to be executed by the plurality of virtual computing instances.

In accordance with further embodiments, the one or more deterministic security attributes are developed through dynamic analysis of code to be executed by the plurality of virtual computing instances.

In accordance with further embodiments, the operations further comprise deploying the plurality of virtual computing instances together with the corresponding set of security rules in the vehicle computing network.

In accordance with further embodiments, the operations further comprise monitoring functionality of the plurality of virtual computing instances during live operations in the vehicle computing network.

In accordance with further embodiments, the operations further comprise identifying, based on the monitored functionality, potential deviations from the corresponding set of security rules.

Additional disclosed embodiments include a non-transitory computer readable medium including instructions that, when executed by at least one processor, cause the at least one processor to perform operations for testing downloadable applications in a virtualized environment corresponding to a vehicle. The operations may comprise identifying a request for an external application to be downloaded to a memory in a vehicle through an over-the-air connection; storing the external application in a secure, sandboxed memory space within the vehicle; executing the external application in a virtualized network environment, the virtualized network environment being configured to simulate at least a portion of a live in-vehicle communications network of the vehicle; determining, based on the execution of the external application in the virtualized network environment, whether the external application has attempted to control at least one vehicle ECU from a group of sensitive ECUs; and generating a prompt, based on the determination, indicating whether the external application is potentially malicious.

In accordance with further embodiments, the virtualized network environment is based on current settings of a plurality of operational ECUs in the vehicle.

In accordance with further embodiments, the virtualized network environment is based on current settings of a subset of the plurality of operational ECUs in the vehicle.

In accordance with further embodiments, the attempt to control includes modifying software stored on the at least one vehicle ECU.

In accordance with further embodiments, the attempt to control includes modifying software stored on the non-transitory computer readable medium.

In accordance with further embodiments, the attempt to control includes adding software to the at least one vehicle ECU.

In accordance with further embodiments, the attempt to control includes causing the at least one vehicle ECU to perform a software-based operation.

In accordance with further embodiments, the group of sensitive ECUs includes an ECU configured to perform a steering function within the vehicle.

In accordance with further embodiments, the group of sensitive ECUs includes an ECU configured to perform a braking function within the vehicle.

In accordance with further embodiments, the group of sensitive ECUs includes an ECU configured to perform an acceleration function within the vehicle.

In accordance with further embodiments, the group of sensitive ECUs includes an ECU configured to perform an optical monitoring function within the vehicle.

In accordance with further embodiments, the group of sensitive ECUs includes an ECU configured to perform an airbag deployment function within the vehicle.

Additional disclosed embodiments include a method for testing downloadable applications in a virtualized environment corresponding to a vehicle. The method may comprise identifying a request for an external application to be downloaded to a memory in a vehicle through an over-the-air connection; storing the external application in a secure, sandboxed memory space within the vehicle; executing the external application in a virtualized network environment, the virtualized network environment being configured to simulate at least a portion of a live in-vehicle communications network of the vehicle; determining, based on the execution of the external application in the virtualized network environment, whether the external application has attempted to control at least one vehicle ECU from a group of sensitive ECUs; and generating a prompt, based on the determination, indicating whether the external application is potentially malicious.

In accordance with further embodiments, the virtualized network environment is based on current settings of a plurality of operational ECUs in the vehicle.

In accordance with further embodiments, the virtualized network environment is based on current settings of a subset of the plurality of operational ECUs in the vehicle.

In accordance with further embodiments, the attempt to control includes modifying software stored on the at least one vehicle ECU.

In accordance with further embodiments, the attempt to control includes adding software to the at least one vehicle ECU.

In accordance with further embodiments, the attempt to control includes causing the at least one vehicle ECU to perform a software-based operation.

In accordance with further embodiments, the group of sensitive ECUs includes an ECU configured to perform a braking function within the vehicle.

In accordance with further embodiments, the group of sensitive ECUs includes an ECU configured to perform an acceleration function within the vehicle.

Additional disclosed embodiments include a non-transitory computer readable medium including instructions that, when executed by at least one processor, cause the at least one processor to perform operations for utilizing an ECU processor identifier as a key to access a key table. The operations may comprise maintaining a secure key table that is accessible to a plurality of ECUs in a vehicle, the secure key table storing a plurality of cryptographic keys useable in encrypting data communications by the plurality of ECUs; and configuring the secure key table so that the plurality of cryptographic keys are inaccessible to the plurality of ECUs unless the plurality of ECUs present a valid decryption key to the secure key table; and wherein an instance of a valid decryption key is an ECU-specific key generated based on a processor identifier associated with a processor within at least one ECU.

In accordance with further embodiments, the instance of the valid decryption key is capable of decrypting the secure key table to access at least one of the plurality of cryptographic keys.

In accordance with further embodiments, the instance of the valid decryption key is capable of decrypting the secure key table to access at least one of the plurality of cryptographic keys.

In accordance with further embodiments, the operations further comprise storing at least one ECU-specific key in a memory associated with the at least one ECU.

In accordance with further embodiments, the operations further comprise removing the at least one ECU-specific key from the memory associated with the at least one ECU.

In accordance with further embodiments, the ECU-specific key is accessible during a boot process of the processor within the at least one ECU.

In accordance with further embodiments, the ECU-specific key is accessible during initialization of a software image.

In accordance with further embodiments, the operations further comprise obtaining, from the at least one ECU, the processor identifier; generating, based on the processor identifier, the ECU-specific key; and storing, in the secure key table, the ECU-specific key.

In accordance with further embodiments, the processor identifier comprises a portion of a CPUID field associated with the at least one ECU.

In accordance with further embodiments, the portion of the CPUID field is determined during a fabrication process of the at least one ECU.

Additional disclosed embodiments include a method for utilizing an ECU's processor identifier as a key to access a key table. The method may comprise maintaining a secure key table that is accessible to a plurality of ECUs in a vehicle, the secure key table storing a plurality of cryptographic keys useable in encrypting data communications by the plurality of ECUs; and configuring the secure key table so that the plurality of cryptographic keys are inaccessible to the plurality of ECUs unless the plurality of ECUs present a valid decryption key to the secure key table; and wherein an instance of a valid decryption key is an ECU-specific key generated based on a processor identifier associated with a processor within at least one ECU.

In accordance with further embodiments, the instance of the valid decryption key is capable of decrypting the secure key table to access at least one of the plurality of cryptographic keys.

In accordance with further embodiments, the instance of the valid decryption key is capable of decrypting the secure key table to access at least one of the plurality of cryptographic keys.

In accordance with further embodiments, the operations further comprise storing at least one ECU-specific key in a memory associated with the at least one ECU.

In accordance with further embodiments, the operations further comprise removing the at least one ECU-specific key from the memory associated with the at least one ECU.

In accordance with further embodiments, the ECU-specific key is accessible during a boot process of the processor within the at least one ECU.

In accordance with further embodiments, the ECU-specific key is accessible during initialization of a software image.

In accordance with further embodiments, the operations further comprise obtaining, from the at least one ECU, the processor identifier; generating, based on the processor identifier, the ECU-specific key; and storing, in the secure key table, the ECU-specific key.

In accordance with further embodiments, the processor identifier comprises a portion of a CPUID field associated with the at least one ECU.

In accordance with further embodiments, the portion of the CPUID field is determined during a fabrication process of the ECU.

Additional disclosed embodiments include a non-transitory computer readable medium including instructions that, when executed by at least one processor, cause the at least one processor to perform operations for authenticating communications for a controller. The operations may comprise intercepting a communication from a requesting device, the communication being received at a controller and comprising at least one packet; performing deep packet inspection on the at least one packet to identify first authentication data; generating a prompt for sending to an auxiliary device associated with the requesting device for entry of second authentication data; validating the first and second authentication data; determining that the first and second authentication data are valid; and based on the determination, allowing the requesting device to access the controller.

In accordance with further embodiments, the first authentication data comprises a password.

In accordance with further embodiments, the second authentication data comprises a two-factor authentication code.

In accordance with further embodiments, the auxiliary device is at least one of: a smartphone, a tablet, a wearable device, or a personal computer.

In accordance with further embodiments, the communication comprises a software update, a software patch, a network request, or an authentication request.

In accordance with further embodiments, the prompt comprises: an element displaying information identifying at least one of: the controller, the requesting device, or a time of the communication; and an element for receiving a user input of the second authentication data.

In accordance with further embodiments, the operations further comprise based on the determination, allowing the requesting device to execute an operation on the controller, wherein the operation is at least one of: adding content to a memory of the controller, deleting content from the memory of the controller, or halting operations on the controller.

In accordance with further embodiments, the operations further comprise determining a risk level associated with the intercepted communication.

In accordance with further embodiments, the operations further comprise determining that the risk level exceeds a threshold, wherein the generating of the prompt for entry of second authentication data is based on the risk level exceeding the threshold.

In accordance with further embodiments, the operations further comprise adding the requesting device to a blacklist.

Additional disclosed embodiments include a method for authenticating communications for a controller. The method may comprise intercepting a communication from a requesting device, the communication being received at a controller and comprising at least one packet; performing deep packet inspection on the at least one packet to identify first authentication data; generating a prompt for sending to an auxiliary device associated with the requesting device for entry of second authentication data; validating the first and second authentication data; determining that the first and second authentication data are valid; and based on the determination, allowing the requesting device to access the controller.

In accordance with further embodiments, the first authentication data comprises a credential.

In accordance with further embodiments, the second authentication data comprises a randomly generated code.

In accordance with further embodiments, the auxiliary device is at least one of: a smartphone, a tablet, a wearable device, or a personal computer.

In accordance with further embodiments, the communication comprises a software update, a software patch, a network request, or an authentication request.

In accordance with further embodiments, the prompt comprises: an element displaying information identifying at least one of: the controller, the requesting device, or a time of the communication; and an element for receiving a user input of the second authentication data.

In accordance with further embodiments, the method further comprises based on the determination, allowing the requesting device to execute an operation on the controller, wherein the operation is at least one of adding content to a memory of the controller, deleting content from the memory of the controller, or halting operations on the controller.

In accordance with further embodiments, the method further comprises determining a risk level associated with the intercepted communication.

In accordance with further embodiments, the method further comprises determining that the risk level exceeds a threshold, wherein the generating of the prompt for entry of second authentication data is based on the risk level exceeding the threshold.

In accordance with further embodiments, the method further comprises adding the requesting device to a blacklist.

Additional disclosed embodiments include a smart cable connector for use in connecting data-communicating devices in a controller network. The smart cable may comprise at least one interface for coupling to at least one signal conductor, the signal conductor being configured for carrying data communications in the controller network; at least one processor within the at least one interface being configured for executing instructions locally in the at least one interface; and at least one memory for storing a plurality of sets of instructions executable by the at least one processor, the sets of instructions being configured to perform operations. The operations may comprise accessing keys for encrypting or decrypting data communications; encrypting, through reference to a first accessed key, at least a first subset of the data communications; and decrypting, through reference to a second accessed key, at least a second subset of the data communications.

In accordance with further embodiments, the at least one interface includes a first interface disposed at one end of a data communications cable, and a second interface disposed at an opposite end of the data communications cable, wherein the second interface includes at least one processor and at least one memory.

In accordance with further embodiments, the first subset of data communications comprises outgoing data communications and the second subset of data communications comprises incoming data communications.

In accordance with further embodiments, the operations further include determining to not encrypt, through reference to a stored key, at least a third subset of the data communications.

In accordance with further embodiments, the operations further include determining to validate the second subset of the data communications upon the decryption being successful.

In accordance with further embodiments, the operations further include determining to block the second subset of the data communications upon the decryption being unsuccessful.

In accordance with further embodiments, the at least one interface is part of a wiring harness for a controller area network in a vehicle.

In accordance with further embodiments, the at least one signal conductor is conductive for transmitting electronic representations of the data communications.

In accordance with further embodiments, the at least one signal conductor is conductive for transmitting optical representations of the data communications.

In accordance with further embodiments, the at least one interface is configured for coupling to a plurality of signal conductors to communicate with a plurality of controllers in the controller network.

Additional disclosed embodiments include a method for connecting data-communicating devices in a controller network, the method being performed by at least one processor within at least one interface of a smart cable connector. The method may comprise accessing at least one memory within the interface of the smart cable connector for storing a plurality of sets of instructions executable by the at least one processor; accessing keys for encrypting or decrypting data communications; executing a first of the plurality of sets of instructions for encrypting, through reference to a first accessed key, at least a first subset of data communications; and executing a second of the plurality of sets of instructions for decrypting, through reference to a second accessed key, at least a second subset of data communications.

In accordance with further embodiments, the at least one interface includes a first interface disposed at one end of a data communications cable, and a second interface disposed at an opposite end of the data communications cable, wherein the second interface includes at least one processor and at least one memory.

In accordance with further embodiments, the first subset of data communications comprises outgoing data communications and the second subset of data communications comprises incoming data communications.

In accordance with further embodiments, the method further includes determining to not encrypt, through reference to a stored key, at least a third subset of the data communications.

In accordance with further embodiments, the method further includes determining to validate the second subset of the data communications upon the decryption being successful.

In accordance with further embodiments, the method further includes determining to block the second subset of the data communications upon the decryption being unsuccessful.

In accordance with further embodiments, the at least one interface is part of a wiring harness for a controller area network in a vehicle.

In accordance with further embodiments, the at least one signal conductor is conductive for transmitting electronic representations of the data communications.

In accordance with further embodiments, the at least one signal conductor is conductive for transmitting optical representations of the data communications.

In accordance with further embodiments, the at least one interface is configured for coupling to a plurality of signal conductors to communicate with a plurality of controllers in the controller network.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 depicts an example of a vehicle communications network that includes controllers having access to a rule table, consistent with embodiments of the present disclosure.

FIG. 2 depicts an example of a configuration of a processor and components related to a virtual environment, consistent with embodiments of the present disclosure.

FIG. 3 illustrates an example of a vehicle communications network that includes ECUs and a remote database, consistent with embodiments of the present disclosure.

FIG. 4 depicts an example of a remote database, consistent with embodiments of the present disclosure.

FIG. 5 depicts an example of a virtualization ID table, consistent with embodiments of the present disclosure.

FIG. 6 illustrates an example of a security rule program overview, consistent with embodiments of the present disclosure.

FIG. 7 illustrates an example of a vehicle communications network that includes ECUs and a remote application server, consistent with embodiments of the present disclosure.

FIG. 8 illustrates an example of an infotainment system graphical user interface (GUI) configured to enable file downloads, consistent with embodiments of the present disclosure.

FIG. 9 depicts an example of a configuration of a computer with an external application server, consistent with embodiments of the present disclosure.

FIG. 10 depicts an example of virtual testing variables applied to a controller in a virtual testing environment, consistent with embodiments of the present disclosure.

FIG. 11 depicts an example of a vehicle communications network that includes controllers and a cryptographic key table, consistent with embodiments of the present disclosure.

FIG. 12 depicts an example of a configuration of a car computer with an ECU having a CPU ID, consistent with embodiments of the present disclosure.

FIG. 13 is a flowchart of an exemplary process for providing security rules to a controller using a virtual computing instance, consistent with embodiments of the present disclosure.

FIG. 14 is a flowchart of an exemplary process for providing security to a vehicle based on testing a downloaded application in a virtual environment, consistent with embodiments of the present disclosure.

FIG. 15 is a flowchart of an exemplary process for generating cryptographic keys to a controller based on a unique identifier, consistent with embodiments of the present disclosure.

FIG. 16 is a flowchart of an exemplary process for providing cryptographic keys to a controller based on a unique identifier, consistent with embodiments of the present disclosure.

FIG. 17 is an illustration of an exemplary register of a CPU, consistent with embodiments of the present disclosure.

FIG. 18 depicts an example of a controller network connected to a user device, consistent with embodiments of the present disclosure.

FIG. 19 is a flowchart of an exemplary process for protecting controllers with two-factor authentication, consistent with embodiments of the present disclosure.

FIG. 20 depicts an example of a smart cable, consistent with embodiments of the present disclosure.

FIG. 21 is a flowchart of an exemplary process for securing data communications, consistent with embodiments of the present disclosure.

### DETAILED DESCRIPTION OF EXEMPLARY EMBODIMENTS

Reference will now be made in detail to exemplary embodiments, examples of which are illustrated in the accompanying drawings and disclosed herein. Wherever convenient, the same reference numbers will be used throughout the drawings to refer to the same or like parts. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

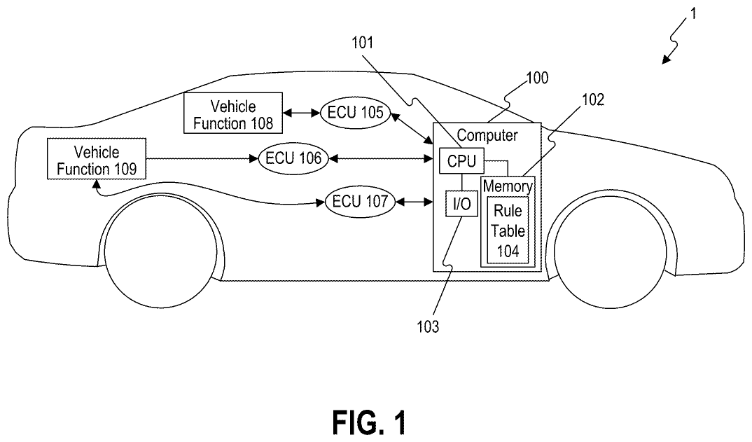

FIG. 1 shows a communications system 1 within a vehicle. This exemplary vehicle communications system 1 may include a computer 100, which may have a central processing unit or CPU 101, memory 102, and an input/output device (I/O) 103. CPU 101 may include one or more dedicated processing units, application-specific integrated circuits (ASICs), field-programmable gate arrays (FPGAs), graphical processing units, or various other types of processors or processing units coupled with memory 102.

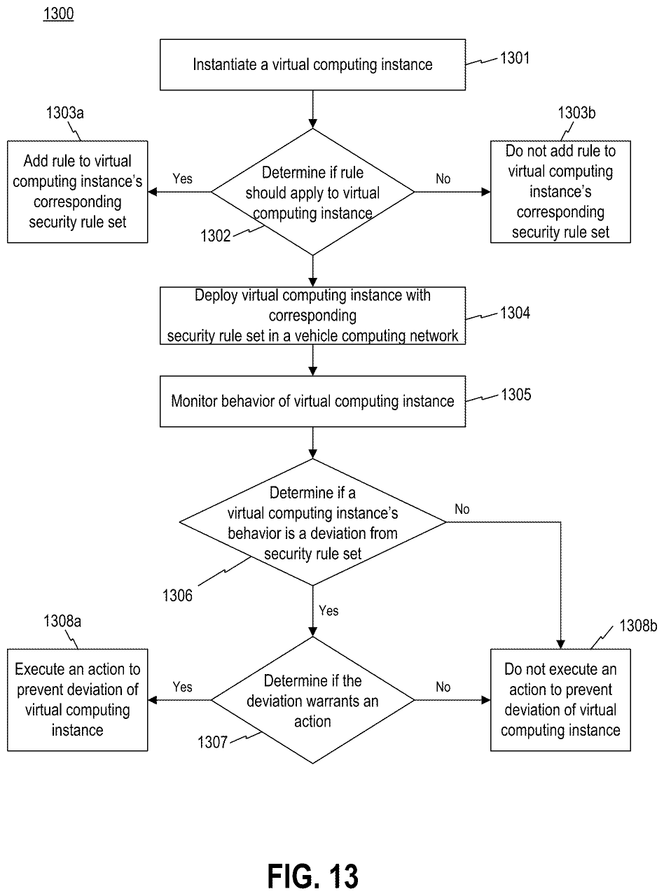

Memory 102 may contain rule table 104, which may have any number of rules, such as rules (e.g., expressed in software code) for execution by CPU 101. In some embodiments, these rules may be used to enforce a deterministic security attribute, condition, or policy associated with an ECU, a vehicle function, and/or a virtual computing instance. Memory 102 may include one or more storage devices configured to store instructions usable by CPU 101 to perform functions related to the disclosed embodiments. For example, memory 102 may be configured with one or more software instructions, such as software program(s) or code segments that perform one or more operations when executed by CPU 101 (e.g., the operations discussed below in connection with FIGS. 13-16). The disclosed embodiments are not limited to separate programs or computers configured to perform dedicated tasks. For example, memory 102 may include a single program or multiple programs that perform the functions of vehicle communications system 1. Memory 102 may also store data that may be used by one or more software programs (e.g., data relating to ECU functions, data obtained during operation of the vehicle, or other data).

In certain embodiments, memory 102 may store software executable by CPU 101 to perform one or more methods, such as the methods represented by the flowcharts depicted in FIGS. 13-16. The software may be implemented via a variety of programming techniques and languages, such as C or MISRA-C, ASCET, Simulink, Stateflow, and various others. Further, it should be emphasized that techniques disclosed herein are not limited to automotive embodiments. Various other IoT environments may use the disclosed techniques, such as smart home appliances, network security or surveillance equipment, smart utility meters, connected sensor devices, parking garage sensors, and many more. In such embodiments, memory 102 may store software based on a variety of programming techniques and languages such as C, C++, PHP, Java, JavaScript, Python, and various others.

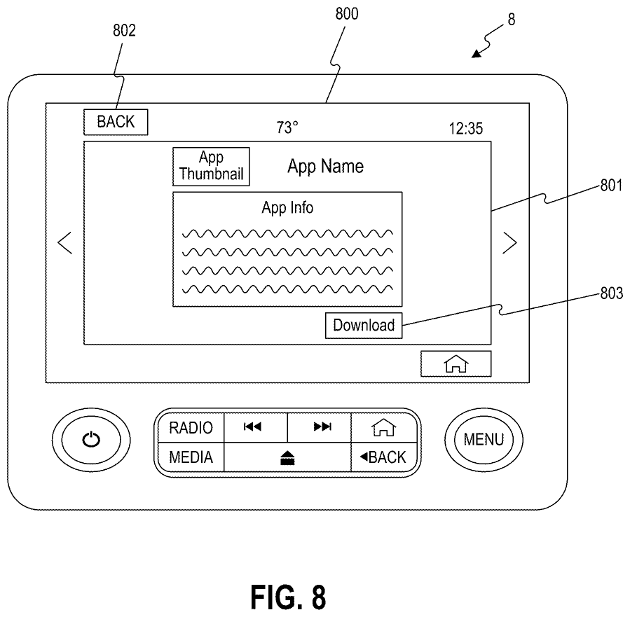

I/O 103 may include at least one of wired and/or wireless network cards/chip sets (e.g., WiFi-based, cellular based, etc.), an antenna, a display (e.g., graphical display, textual display, etc.), an LED, a router, a touchscreen, a keyboard, a microphone, a speaker, a haptic device, a camera, a button, a dial, a switch, a knob, a transceiver, an input device, an output device, or another I/O device configured to perform methods of the disclosed embodiments, as discussed further below. As an example, I/O 103 may be components of a user interface such as that illustrated in FIG. 8.

Computer 100 or vehicle communications system 1 may also have other software and/or physical components not shown, such as a bus that interconnects parts of computer 100 or vehicle communications system 1, removable and/or non-removable computer media, a hard disk, applications, an operating system, programmable code, and programs. An operating system may include a kernel and security middleware layer (not shown).

Computer 100 may be connected to exemplary electronic control units 105, 106, and 107 (hereinafter ECU 105, ECU 106, and ECU 107). Of course, while electronic control units 105, 106, and 107 are illustrated as automotive-specific controllers (e.g., manufactured by companies such as Bosch™, Delphi Electronics™, Continental™, Denso™, etc.), non-automotive controllers may be implemented as well. For example, Skyworks™, Qorvo™, Qualcomm™, NXP Semiconductors™, or other types of IoT controllers may be used in some embodiments. Connections between computer 100 and ECUs 105, 106, and 107 may be accomplished through a communication channel, which may include a bus, a cable, a wireless communication channel, a radio-based communication channel, a local area network (LAN), the Internet, a wireless local area network (WLAN), a wide area network (WAN), a cellular communication network, or any Internet Protocol (IP) based communication network and the like. ECUs 105, 106, and 107 may be associated with vehicle functions 108 and 109. These vehicle functions may include steering, braking, acceleration, engine control, airbag control, navigation systems, external communications (i.e., communications between the vehicle and a device external to the vehicle), door-locking, infotainment, camera monitoring, control of external vehicle lights (e.g., headlights, taillights, and/or turn signals), and/or sensor detection (e.g., operation of blind-spot monitoring sensors). An ECU may be associated with a single vehicle function (such as shown with respect to ECU 105) or multiple vehicle functions. Moreover, in some embodiments, a vehicle function (such as vehicle function 109) may be associated with multiple ECUs. In some embodiments, computer 100 may itself be an ECU.

While vehicle communications system 1 is depicted within a vehicle in FIG. 1, it should be noted that some or all portions of the system may exist separate from a vehicle. For example, computer 100 may be a standalone computer connected to any number of controllers (rather than ECUs) in a non-automotive environment, such as a network of devices in a personal residence, an IoT environment in an enterprise network, etc.

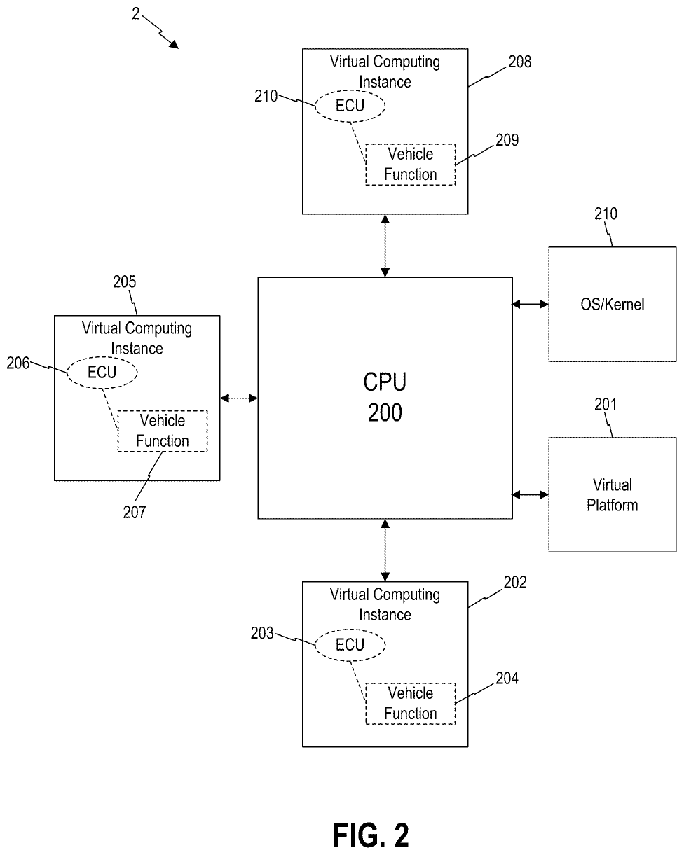

FIG. 2 depicts an exemplary configuration 2 of a CPU 200 and components related to a virtual controller environment. CPU 200 may operate within a vehicle network (e.g., as CPU 101) or in various other types of IoT networks. CPU 200 may include one or more dedicated processing units, application-specific integrated circuits (ASICs), field-programmable gate arrays (FPGAs), or various other types of processors or processing units. CPU 200 may be connected with an operating system and/or kernel (OS/kernel) 210, which may be used within a virtual computing environment. CPU 200 may also be configured to connect with and use a virtual platform 201, which can imitate a physical system using software. In some embodiments, CPU 200 may instantiate (i.e., spin up) virtual computing instances 202, 205, and 208. These virtual computing instances may be virtual machines (VMs), container resources (e.g., Docker™ containers), serverless code instances, or other virtual computing instances. In some embodiments, a virtual machine, after it is instantiated, may have its own (i.e., non-shared) OS, kernel, and/or applications. A container resource, on the other hand, may share at least a kernel with other container resources, either when instantiated or at another point in time. CPU 200 may act as an orchestrator of a virtual computing instance, such as by controlling an associated workflow.

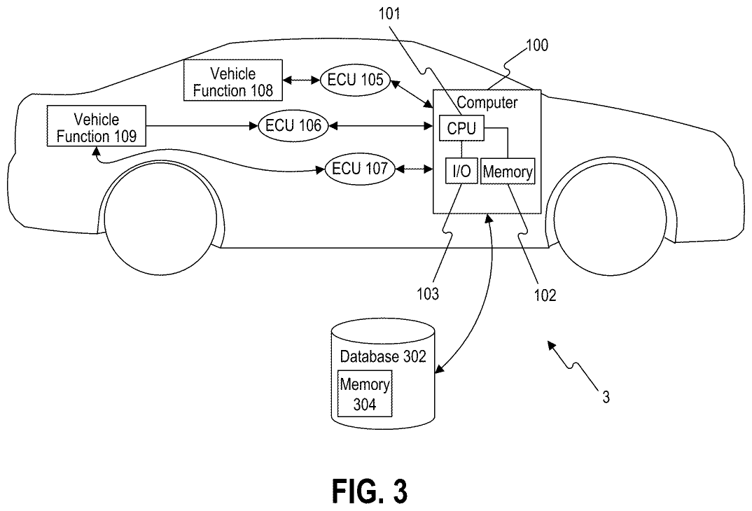

Virtual computing instances 202, 205, and 208 may emulate or be otherwise associated with an ECU and/or vehicle function. For example, virtual computing instance 202 may be spun up to emulate or perform the braking operation of a vehicle, such that ECU 203 may be associated with braking of a vehicle (e.g., actuating a brake pad or other braking system), and vehicle function 204 may be the vehicle's braking function. In some embodiments, a virtual computing instance may be spun up on demand to emulate or perform a particular vehicle function, which may or may not be live (i.e., currently operating within a vehicle). This may be done automatically, such as in response to a strain or load on a particular device in a vehicle. In some embodiments, virtual computing instances may be instantiated in response to a user input, either at the vehicle or remotely from it. In other embodiments, virtual computing instances may be instantiated in response to a particular action of vehicle communication network 1, such as a system boot or detection of high system load for a particular function. Multiple virtual computing instances may also be instantiated simultaneously or near simultaneously (e.g., to emulate an entire vehicle network). In some embodiments, a virtual computing instance may be monitored over a period of time (e.g., by CPU 200), to detect anomalous or dangerous behavior (e.g., behavior that deviates from a rule set, discussed below with respect to FIGS. 3-6 and 13).

In some embodiments, a virtual computing instance may emulate multiple ECUs and/or multiple vehicle functions. Virtual computing instances may be terminated (i.e., spun down) in response to a user command, or automatically, such as based on low usage of a vehicle component in a live environment (e.g., an operating vehicle). For example, when a vehicle is parked, a virtual computing instance associated with an acceleration function or anti-lock brakes function may be spun down.

FIG. 3 shows an example of a vehicle communications system 3 that includes one or more controllers and a remote database. In this example, vehicle communications system 3 is connected to database 302, which contains memory 304. In some embodiments, database 302 is external to vehicle communications system 3 and may be operated by a vehicle security provider and/or cloud services provider. Database 302 may communicate with vehicle communications system 3 using a communications channel, which may include a bus, a cable, a wireless communication channel, a radio-based communication channel, the Internet, a local area network (LAN), a wireless local area network (WLAN), a wide area network (WAN), a cellular communication network, and/or an Internet Protocol (IP) based communication network and the like. In some embodiments, the communications channel may be based on public cloud infrastructure, private cloud infrastructure, hybrid public/private cloud infrastructure, or no cloud infrastructure.

In some embodiments, database 302 may send or receive data used for instantiation, operation, or spinning down of virtual computing instances. In some embodiments, vehicle communications system 3 may be equipped with one or more compatible receivers (not shown) configured to support communications with database 302 via the communications channel. Database 302 may also be an instance of computer 100 in some embodiments. Further, in some embodiments database 302 may store security rules or policies to be implemented via one or more of controllers 105, 106, and 107.

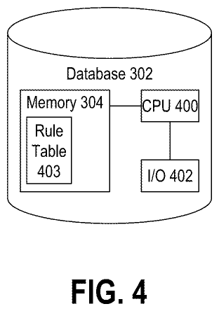

FIG. 4 depicts database 302, which may include CPU 400, which may be connected to memory 304 and I/O 402. CPU 400, memory 304, and I/O 402 may be the same as or similar to similarly named components described with respect to FIG. 1.

Memory 304 may contain rule table 403, which may have any number of rules for carrying out the disclosed embodiments. For example, in some embodiments, rule table 403 may have rules for enforcing a deterministic security attribute of an ECU, vehicle function, and/or virtual computing instance. Deterministic security attributes may be determined through static and/or dynamic analysis of code to be executed by a virtual computing instance (and potentially an associated device, such as an ECU or other controller). Static analysis may, for example, include receiving models of expected behavior or controller-specific behavior from external sources (e.g., controller manufacturers, etc.). Dynamic analysis, on the other hand, may involve analyzing runtime attributes and performance characteristics of controllers, and establishing normal or expected models of controller behavior.

The rules stored in rule table 403 may be generated by database 302, computer 100, or another device, such as a server that is remote from vehicle communications system 3, which may be part of a cloud-based network for providing vehicle security. Rule table 403 may be updated periodically by removing rules, adding rules, or modifying rules, so that vehicle communications system 3 may be protected against new security threats. These updates may occur as part of a machine-learning process based on, for example, real-time or observed driving conditions of the vehicle or operating conditions of the controllers.

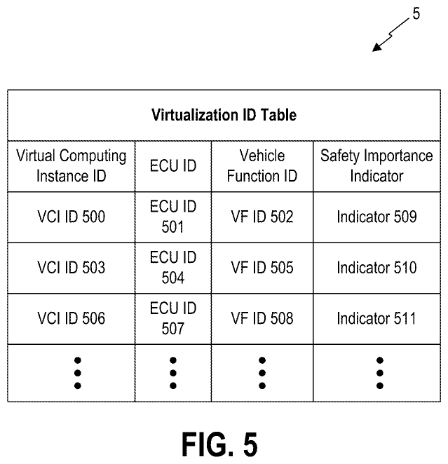

FIG. 5 depicts a virtualization ID table 5. Virtualization ID table 5 may store, such as in a list or spreadsheet format, any number of virtual computing instance (VCI) IDs, such as VCI ID 500, VCI ID 503, and VCI ID 506, etc. A virtual computing instance ID may be associated with a particular ECU, which may be identified by a corresponding ECU ID. For example, VCI ID 500 has an associated ECU that is identified by ECU ID 501. In some embodiments, a virtual computing instance and/or ECU may have an associated vehicle function, consistent with the disclosed embodiments. Such a vehicle function may be identified by a vehicle function ID (VF ID). For example, VCI ID 500 and/or ECU ID 501 have an associated VF ID 502. In some embodiments, a virtual computing instance, ECU, or vehicle function may have an associated safety importance, which may be expressed as a safety importance indicator (e.g., indicator 509, 510, and 511) and stored in virtualization ID table 5.

In some embodiments, a safety importance indicator may express the safety importance of the associated virtual computing instance, ECU, or vehicle function using an absolute value, such as a number between 1 and 10, a percentage, a color, or other expressions. For example, a virtual computing instance and/or ECU associated with a vehicle function of braking may have a safety indicator indicating high safety importance, whereas a virtual computing instance and/or ECU associated with a vehicle function of radio signal processing may have a safety indicator indicating low safety importance. In other embodiments, a safety importance indicator may express the safety importance of the associated virtual computing instance, ECU, or vehicle function using a value relative to the safety importance of other virtual computing instances, ECUs, or vehicle functions, such as through a ranking, hierarchy, percentage, or the like.

Virtualization ID table 5 may be implemented in various types of memory components, including memory 102, memory 304, and/or any other electronic storage medium, consistent with the disclosed embodiments. Virtualization ID table 5 may be accessed by computer 100, database 302, or another device to enforce a deterministic (e.g., learned or pro-programmed) security attribute. In some embodiments, values contained in virtualization ID table 5 may be used to determine if a particular rule, such as a rule contained in rule table 104 or rule table 403, should apply to a particular virtual computing instance, ECU, or vehicle function.

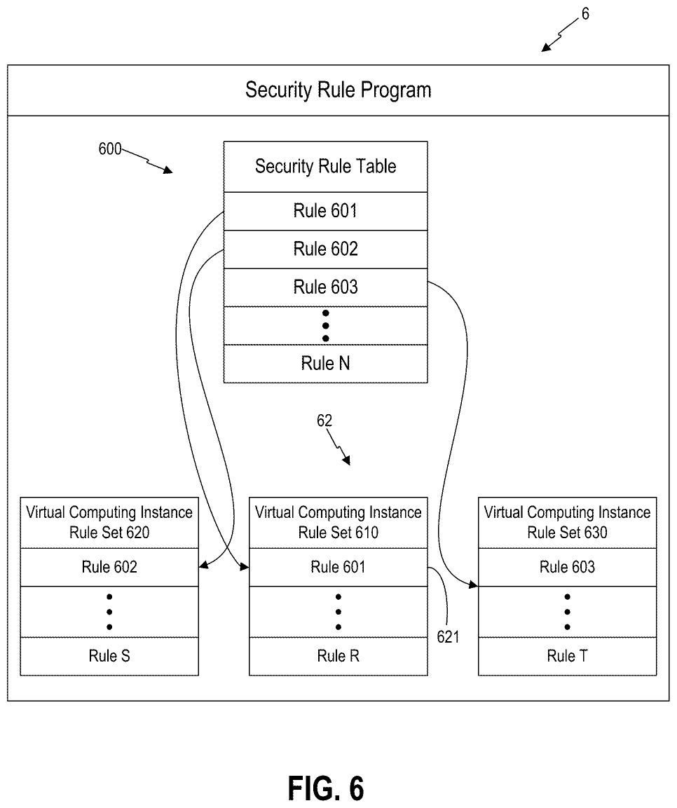

FIG. 6 depicts security rule program 6, which may be executed by computer 100, an ECU or other controller, database 302, or various other computing devices. Security rule program 6 may be stored in a memory component, including memory 102, memory 304, and/or any other electronic storage medium, consistent with the disclosed embodiments. Security rule program 6 includes a security rule table 600, which contains exemplary rules 601, 602, and 603. These rules may be used to enforce security policies for a virtual computing instance, ECU, vehicle function, and/or system (e.g., vehicle communications system 3). When executed by a processor, security rule program 6 may place any combination of rules in security rule table 600 into rule sets (e.g., virtual computing instance rule sets 610, 620, and 630). These rule sets may be stored in memory such as memory 102, memory 304, directly in memory of an ECU or controller, and/or any other electronic storage medium. These virtual computing instance rule sets may have associated rule sets for physical ECUs or other devices (not shown), which may be configured to have rules based on those of the virtual computing instance rule sets (e.g., a rule set for a physical ECU may copy the rules for a virtual computing instance). In some embodiments, the rule sets for the physical ECUs or other devices may also be stored in memory such as memory 102, memory 304, and/or any other electronic storage medium.

In some embodiments, each rule set may be associated with one or more virtual computing instances. For instance, a particular rule set may be associated with a virtual computing instance based on attributes of that virtual computing instance, such as an ECU or vehicle function the virtual computing instance is associated with (e.g., including the safety importance of an ECU or vehicle function), an operational state of a system (e.g., a vehicle), or an operational state of a device within a system. In some embodiments, a single rule set may be associated with multiple virtual computing instances. For example, if virtual computing instance rule set 630 is designed to enforce a security policy for the engine function of a vehicle, and there are multiple virtual computing instances corresponding to multiple ECUs in the vehicle that are associated with the engine function, virtual computing instance rule set 630 may be associated with those multiple virtual computing instances.

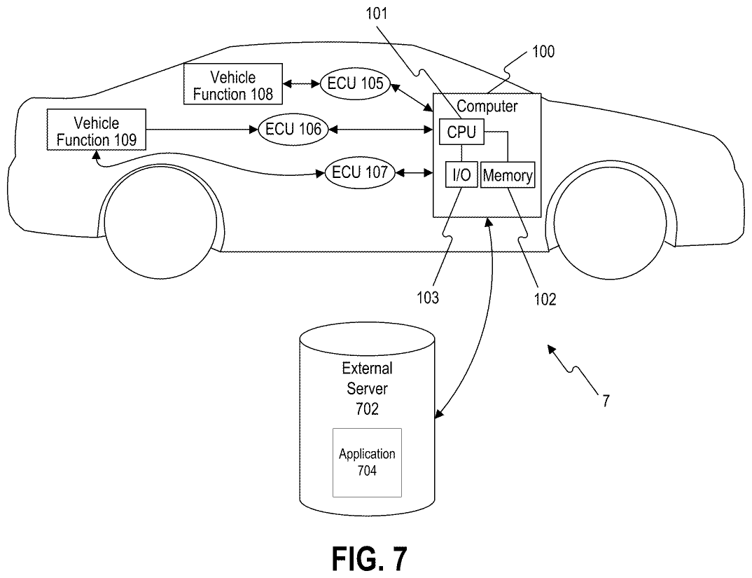

FIG. 7 depicts a vehicle communications system 7 that includes ECUs and a remote application server 702. In this example, vehicle communications system 7 is connected to external server 702. External server 702 may be a special-purpose computer, an instance of computer 100, a computing cluster, a database, or another device capable of storing and sending application data. In some embodiments, external server 702 is external to vehicle electronic communications 7 and may be operated by an application provider or cloud services provider. External server 702 may have a number of applications 704, which may be stored in memory at external server 702. External server 702 may be connected to vehicle communications system 7 through an over-the-air wireless communications connection, which may include a bus, a cable, a wireless communication channel, a radio-based communication channel, the Internet, a local area network (LAN), a wireless local area network (WLAN), a wide area network (WAN), a cellular communication network, and/or an Internet Protocol (IP) based communication network and the like. In some embodiments, external server 702 may send or receive data to or from vehicle communications system 7 using an over-the-air (e.g., cellular, satellite-based, WiFi, etc.) connection. In some embodiments, external server 702 may send or receive data for downloading and/or installing an application (e.g., application 704) at the vehicle communications system 7. In some embodiments, this data may be based on inputs received at an infotainment system of a vehicle, such as those discussed below in connection with FIG. 8.

In some embodiments, external server 702 may receive a request for an application, an application update, or other code from vehicle communications system 7. In response, external server 702 may send a file or files to vehicle communications system 7, which may be used by vehicle communications system 7 to download and install the application. Prior to downloading and/or installing the application, vehicle communications system 7 may test the application using a virtual computing environment, as discussed further below, in order to determine whether the application might have any detrimental impacts to vehicle communications system 7, consistent with the disclosed embodiments.

FIG. 8 depicts an exemplary infotainment system 8, which may be used to initiate a process for testing, downloading, and installing an application to a device within vehicle communications system 7, such as computer 100 or controller 105. In some embodiments, infotainment system 8 has a display 800, which may comprise an LCD screen, an LED screen, a text-based screen, or any other screen capable of displaying text and/or graphic content to the user. In some embodiments, display 800 may comprise a touchscreen that uses any suitable sensing technology (e.g., resistive, capacitive, infrared, stylus, etc.) to receive user input. In such embodiments, display 800 may function as an input device in addition to an output module.

Display 800 may include a variety of interfaces and selectable elements, such as main display area 801, back button 802, and download button 803. In some embodiments, main display area 801 may display visuals based on user interactions with infotainment system 8. For example, a user may interact with infotainment system 8 using physical buttons or knobs, or, if display 800 comprises a touchscreen, a user may interact with infotainment system 8 by touching display 800, such as by touching download button 803. In some embodiments, a user may initiate a process for downloading and/or installing an application on a device within vehicle communications system 7 (e.g., computer 100 or controller 105) by interacting with infotainment system 8 (e.g., by selecting download button 803).

Display 800 may display a variety of information to a user, including a name of an application, a description of an application, and/or information regarding security risk of an application (e.g., a risk level associated with an application, a warning of an unverified publisher of the application). In some embodiments, display 800 may display information based on a determination made by computer 100. For example, if computer 100 determines that an application a user has requested to download to vehicle communications system 7 presents a security threat to the system, as discussed further below, computer 100 may send security risk information to display 800, which display 800 may graphically, audibly, or otherwise present to a user.

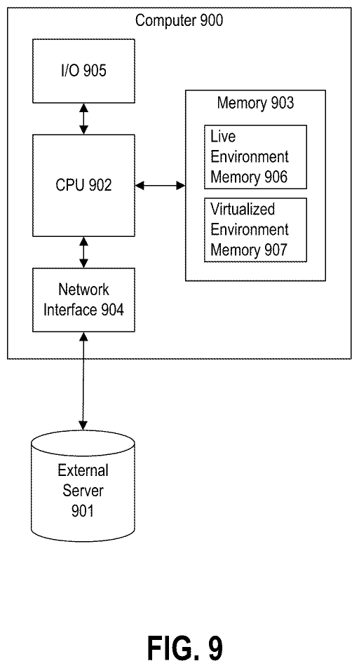

FIG. 9 depicts an exemplary configuration of a computer 900 with an external application server 901. In this configuration, computer 900 includes a CPU 902, memory 903, network interface 904, and input/output devices (hereinafter I/O 905). In some embodiments, network interface 904 (e.g., a wireless cellular interface, WiFi interface, satellite communications interface, wired network interface, etc.) may be part of I/O 905. In this configuration, computer 900 may be connected to external server 901, such as through an over-the-air wireless communications connection. In some embodiments, computer 900 and/or any of CPU 902, memory 903, network interface 904, I/O 905, live environment memory 906, or virtualized environment memory 907 may exist as part of a virtual computing instance, such as those discussed with respect to FIG. 2. Moreover, computer 900 may be an instance of computer 100. In some embodiments, computer 900 may be external to a vehicle communications system, such as those discussed with respect to FIGS. 1, 3, and 7.

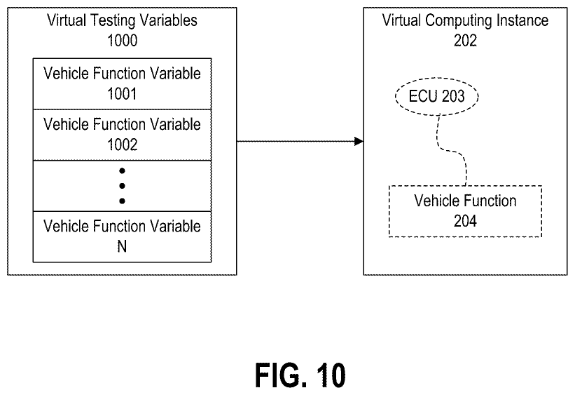

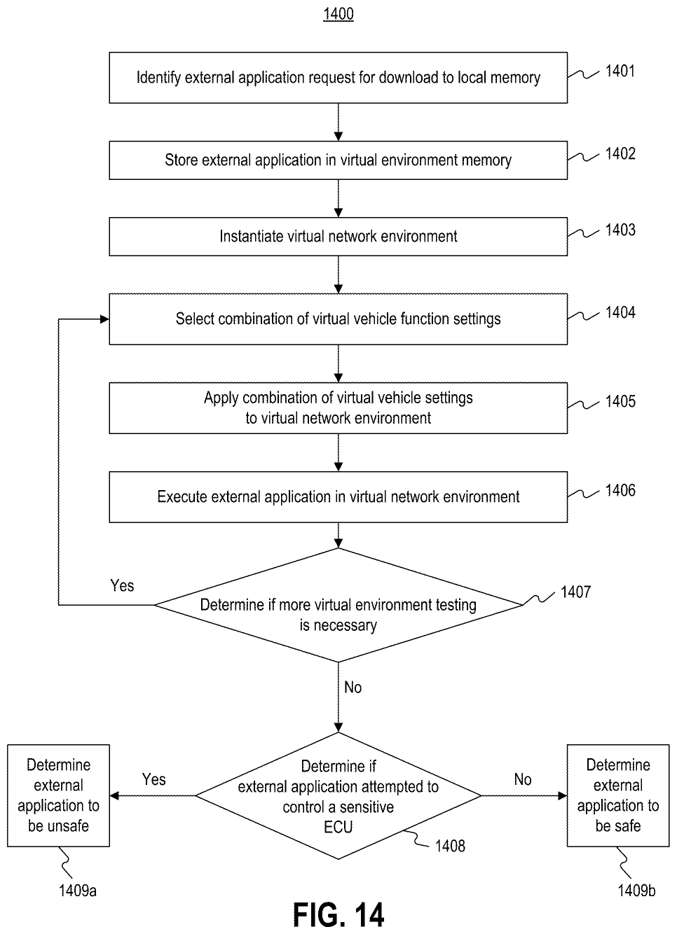

Memory 903 may include one or more live environment memory 906 and virtualized environment memory 907. In some embodiments, memory 903 may be a single memory component, such that live environment memory 906 and virtualized environment memory 907 are separate portions (such as partitions) of memory on the single memory. In other embodiments, memory 903 may comprise multiple memory components, with live environment memory 906 and virtualized environment memory 907 existing separately on different memory components. In some embodiments, live environment memory 906 may be designated for storing data related to live operations being performed by a device, such as ECU 104. In some embodiments, live environment memory 906 and virtualized environment memory 907 may be on separate memories 903 on separate computers 900. Virtualized environment memory 907 may include a portion designated as a “sandbox,” which may be configured to store an application safely (e.g., in memory space lacking network or other connections and/or in a read-only memory space), such that it cannot perform an operation within vehicle communications system 7 or otherwise interact with vehicle communications system 7. After storing an application, it may be tested in a virtualized computing environment prior to installation within vehicle communications system 7, as discussed below with respect to FIGS. 10 and 14.

External server 901 may be situated separately from computer 900 and may connect to computer 900 through network interface 904, such as by using an over-the-air connection as discussed above. Network interface 904 may include, without limitation, any of a wired and/or wireless network card/chip set (e.g., cellular-based, satellite-based, WiFi, etc.), an antenna, a router, etc. External server 901 may include or connect to a database or other storage medium storing an application. In some embodiments, external server 901 may send an application and/or related data to computer 900. This may be done in response to an input received at computer 900 and/or infotainment system 8, which may be an instance of, or connected to, computer 900.

FIG. 10 depicts an application of virtual testing variables 1000 to an ECU or other controller in a virtual testing environment. Virtual testing variables 1000 may be a set of variables associated with different vehicle functions (e.g., vehicle function variable 1001, vehicle function variable 1002, etc.). For example, vehicle function variable 1001 may represent a degree of vehicle acceleration and vehicle function variable 1002 may represent an ignition status of a vehicle. Virtual testing variables 1000 may be applied to virtual computing instance 202 to cause changes in the virtual testing environment. By operating ECU or controller 203 and vehicle function 204 in a virtual computing environment and applying virtual testing variables 1000 to that environment, virtual computing instance 202 may be able to monitor the behavior of ECU or controller 203 and/or vehicle function 204 to observe any changes.

In some embodiments, virtual testing variables 1000 may be based on current settings of any number of ECUs or controllers, which may be operating in a live environment (e.g., an operating vehicle, a functioning IoT network, etc.). For example, if controllers 105, 106, and 107 are operating according to a set of live settings, those settings may be represented by virtual testing variables 1000 for use within a virtual testing environment. In some embodiments, virtual testing variables 1000 may be based on certain predetermined combinations of ECU settings. For example, a particular combination may simulate a “stress test” on a virtual computing environment that may emulate vehicle functions. By applying different combinations of settings of virtual testing variables 1000, a virtual computing instance can emulate a number of controllers, or even an entire vehicle or IoT system, operating under different conditions. In some embodiments, an application, such as one having been stored in virtualized environment memory 907, may be tested in these different emulations to uncover any anomalous, threatening, or otherwise unwanted behaviors occurring at an ECU or other component within a vehicle or IoT system, which may be observable under certain combinations of conditions (e.g., vehicle function variables), but not others.

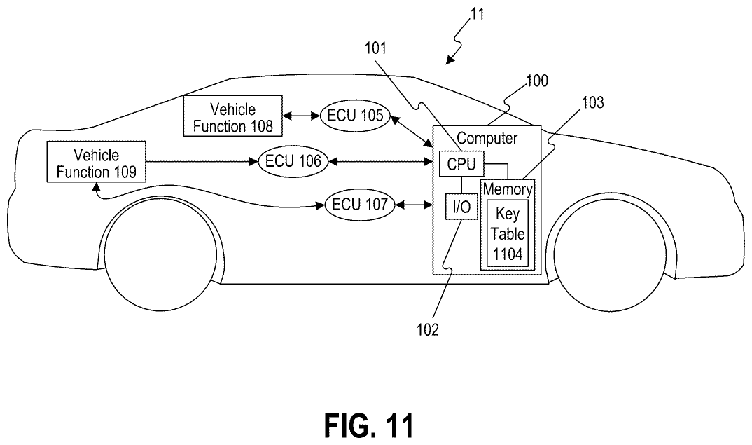

FIG. 11 depicts an exemplary vehicle communications system 11 that includes ECUs or other controllers 105, 106, 107, and a cryptographic key table 1104. In this example, vehicle communications system 11 includes a key table 1104, which is included as part of memory 103. In some embodiments, key table 1104 may store cryptographic keys that can be used to encrypt and/or decrypt communications within vehicle communications system 11. According to various disclosed embodiments, the keys may be symmetric (e.g., based on algorithms such as AES, Twofish, Serpent, Blowfish, CAST5, RC4, DES, 3DES, etc.) or asymmetric (e.g., based on algorithms such as RSA, Diffie-Hellman, DSS, etc.). The cryptographic keys may be associated with specific ECUs within vehicle communications system 11. For example, key table 1104 may contain a cryptographic key configured only for decrypting communications sent to ECU 106 from another device within vehicle communications system 11. In some embodiments, key table 1104 may also contain controller identifiers, a system identifier (e.g. a vehicle identifier), signatures, and/or other data for encrypting or decrypting communications.

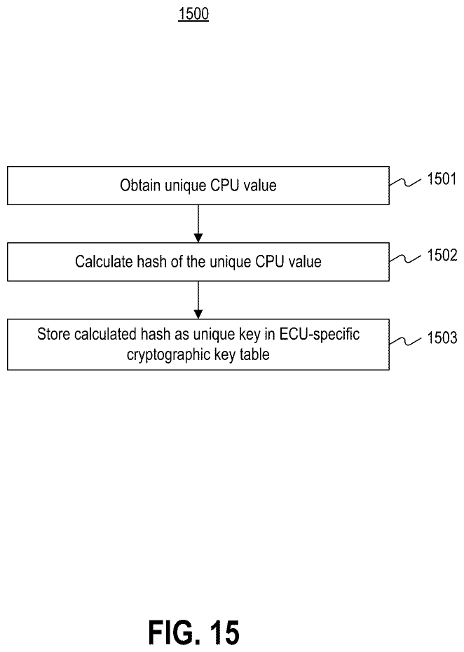

In some embodiments, computer 100 or an ECU (such as exemplary controllers 105, 106, or 107) may generate a cryptographic key and send it to computer 100. Upon receipt of the key, computer 100 may store it at key table 1104. This may be accomplished by the process described further below with respect to FIG. 15.

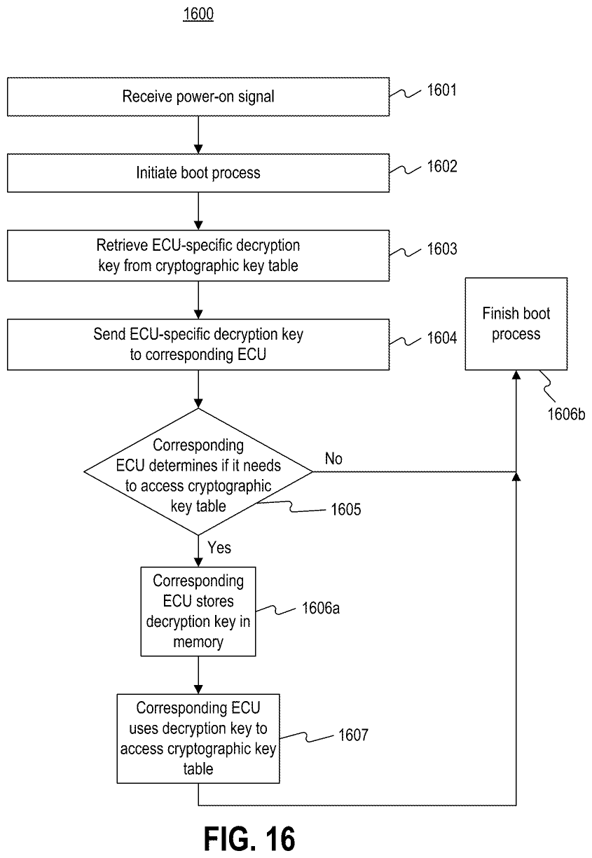

In some embodiments, computer 100 or an ECU may query key table 1104 for any number of cryptographic keys. For example, ECU 105 may have received a communication from ECU 106, and may query key table 1104 for a decryption key configured to decrypt communications from ECU 106. In some embodiments, key table 1104 may itself be encrypted. To access encrypted key table 1104 in this example, ECU 105 may need to present a decryption key unique to itself. In some embodiments, a unique decryption key may only be retrieved during specific processes, such as initialization of software or boot of vehicle communications system 11. Retrieval of cryptographic keys stored in key table 1104 may be accomplished by the process described further below with respect to FIG. 16.

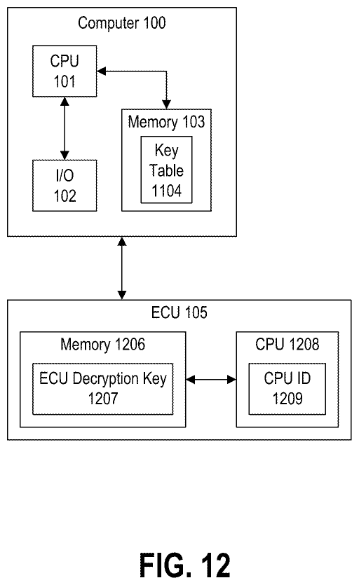

FIG. 12 depicts an example of a configuration of a computer 100 with an ECU having a CPU with a CPU ID. In this configuration, computer 100 includes memory 103, which may store key table 1104. Computer 100 may also be also connected (e.g., via wireless communications, via a vehicle communications bus, via another type of wired connection, etc.) to ECU 105 as described with respect to FIG. 1.

In this exemplary configuration, ECU 105 contains memory 1206 and CPU 1208. Memory 1206 may access and/or store and use ECU decryption key 1207, which may have been received from key table 1104 through the connection between computer 100 and ECU 105. Memory 1207 may also be connected to CPU 1208, which may have a unique CPU ID 1209.

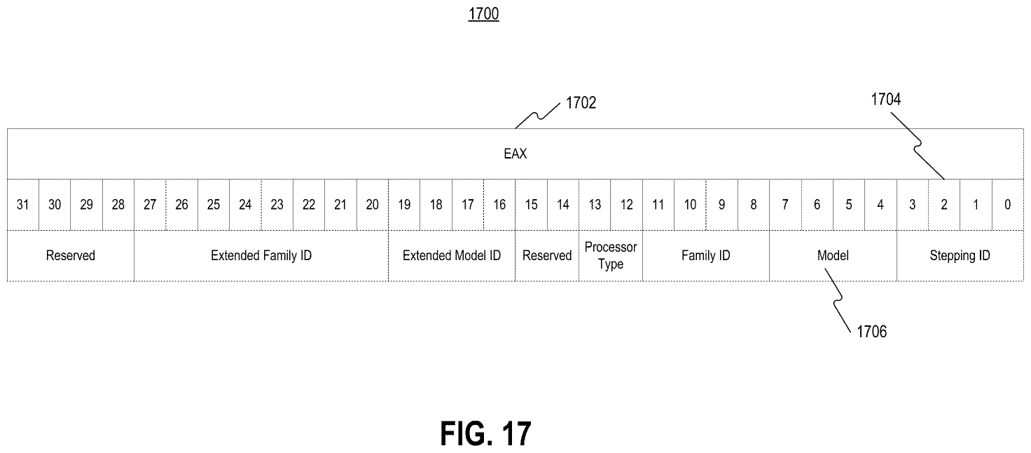

CPU ID 1209 may be any unique, inherent, or custom information associated with CPU 1208. In some embodiments, this information may be entirely unique to CPU 1208. In some embodiments, CPU ID 1209 may be a portion of processor information that may be obtained using a CPUID instruction that is associated with some processors, which may use the EAX register (an example of which is shown at FIG. 17) to determine particular values to return from a CPU. In some embodiments, CPU ID 1209 may be the value or values returned when the CPUID instruction is called for CPU 1208 with the EAX register set to zero. In some embodiments, the value or values returned may come from registers of CPU 1208, such as EAX, EBX, ECX, or EDX. CPU 1208 may have a register called CPUID, which may be designated as a CPU identification register, which may be a type of special function register (SFR). Any of these registers may be read-only, and/or may hold a value whose bit-length is determined by a manufacturer of the CPU.

In some embodiments, the CPUID register may be accessed using an instruction structured for addressing an SFR. In some embodiments, CPUID register may provide a unique CPU identifier for an ECU in a vehicle. In some instances, CPU ID 1209 may comprise a certain bitlength (e.g. 32 bits) which may provide a high level of security for encrypted communications (e.g., such as by using process 1500). Any of the values stored in a register of CPU 1208 may be determined and fixed (e.g., stored in a read-only register) at the time CPU 1208 was fabricated or went through initial configuration.

FIG. 13 illustrates an exemplary process 1300 for deploying a virtualized ECU or other controller (e.g., IoT controller), such as virtual computing instance 202. In accordance with above embodiments, process 1300 may be implemented in vehicle communications system 3 depicted in FIG. 3, or in various other types of IoT environments. For example, process 1300 may be performed by a processor in a communications network of a vehicle (e.g., CPU 101 in vehicle communications system 3) or by an external device (e.g., database 302), or at an IoT system. Such a processor may operate, for example, according to configuration 2 as discussed above. Regardless of the particular device performing process 1300, in some embodiments it may be performed using database 302, virtualization ID table 5, security rule program 6, in addition to elements of configuration 2 and/or vehicle communications system 3.

At step 1301, process 1300 may instantiate a virtual computing instance. This virtual computing instance may be a virtual machine (VM), container resource, serverless code, or other virtual computing software. In some embodiments, the instantiation of the virtual instance may occur on-demand or in a just-in-time manner. For example, when a vehicle is off or idle, the computing requirements of the vehicle may be minimal (e.g., limited to a security system, software update module, keyless entry system, etc.). When the vehicle becomes operational, however, additional computing resources may be needed (e.g., acceleration, steering, power steering, braking, anti-lock braking, window control, lighting, etc.). Further, during an operation phase of the vehicle, as conditions change (e.g., rain begins, bumpy terrain is encountered, etc.) additional computing capabilities may be needed (e.g., windshield wipers, traction control, etc.). In some embodiments, virtual computing instances, may be spun up to anticipate or react to these dynamic conditions of the vehicle. For example, in some embodiments a user's detected approach to the vehicle (e.g., based on signals or signal strength from a keyless entry device, smartphone, etc.) may be a prompt to instantiate virtual computing instances associated with vehicle operation. Further, in some embodiments map or weather data may be retrieved (e.g., from an onboard infotainment system, from external map or weather sources, etc.) and used to detect future changes in road conditions, terrain, or weather. In response to such changing conditions, additional virtualized instances (e.g., windshield wiper controller instances, traction control instances, etc.) maybe instantiated upon demand. When the terrain or weather changes again (e.g., rain disappears, road conditions return to normal, etc.), instances that were spun up to meet those conditions may be spun down on demand. These are other techniques are within the scope of process 1300.

At step 1302, process 1300 may determine if a rule should apply to a virtual computing instance. In some embodiments, this rule comes from rule table 104 and/or security rule table 600. In other embodiments, a rule may originate from a remote source to a vehicle (e.g., database 302). In some embodiments, process 1300 may determine if a rule should apply to a virtual computing instance based on whether the rule is associated with a live operating environment of a vehicle. In other embodiments, process 1300 may determine if a rule should apply to a virtual computing instance based on whether it is appropriate for enforcing a deterministic security attribute of the virtual computing instance. Process 1300 may also determine if a rule should apply to a virtual computing instance based on an ECU or vehicle function associated with that virtual computing instance (e.g., the more sensitive an ECU associated with the virtual computing instance is, the more rules that may apply).

If process 1300 determines that a rule should apply to a virtual computing instance, process 1300 proceeds to step 1303a. At step 1303a, process 1300 adds the rule to a security rule set for that virtual computing instance (e.g., virtual computing instance rule set 620).

If process 1300 determines that a rule should not apply to a virtual computing instance, process 1300 proceeds to step 1303b. At step 1303b, process 1300 does not add the rule to a security rule set for that virtual computing instance (e.g., virtual computing instance rule set 620).

Process 1300 may perform steps 1302, 1303a, and 1303b (as well as any other steps discussed) iteratively. For example, these steps may be performed for a portion of a list of rules from a rule table 104 or a security rule table 600 (i.e., the steps may be performed once per rule in one of these tables).

At step 1304, process 1300 deploys a virtual computing instance with a security rule set. The virtual computing instance may be deployed in a vehicle computer network, such as vehicle communications system 3, or in various other types of IoT network environments.

At step 1305, process 1300 monitors behavior of the virtual computing instance. In some embodiments, monitoring behavior of the virtual computing instance involves examining processes, calls, and other operations occurring within the virtual computing instance. In some embodiments, process 1300 may intercept commands from an application layer of a controller to a kernel of a controller. Process 1300 may perform in-memory validation to intercepted commands or other parts of code as part of monitoring behavior of the virtual computing instances, such as by applying an in-memory graph to code portions associated with a virtual computing instance. These techniques and others are described in further detail in Applicant's U.S. Pat. No. 10,204,219, which is incorporated by reference herein.

At step 1306, process 1300 determines if a virtual computing instance's behavior is a deviation from a security rule set (e.g., virtual computing instance rule set 620). This determination may be based on actions (or non-actions) of an ECU and/or vehicle function emulated within a virtual computing instance (e.g., ECU 203 and/or vehicle function 204). These actions may include operations performed (e.g., activation of a vehicle function, communications between devices such as ECUs, communications between devices within a vehicle and devices external to a vehicle), an instruction executed, an amount of power consumed over a length of time, and/or an amount bandwidth consumed over a length of time. This determination may also be based on a pattern, sequence, or frequency of actions or non-actions taken by an ECU and/or vehicle function emulated within a virtual computing instance.

In some embodiments, process 1300 may save data (e.g., trace information) relating to the determination of whether a virtual computing instance's behavior is a deviation from a security rule set (e.g., at memory 102 and/or database 302). This information may be analyzed at database 302 or elsewhere to adjust the determination of rules to add to a security rule set at step 1302. The rule set may then be applied from database 302 to multiple ECUs across multiple vehicles. Therefore, an action deviating from a rule set of one virtual computing instance may be used to harden ECUs across multiple vehicles.

If process 1300 determines that a virtual computing instance's behavior is not a deviation from a security rule set, process 1300 proceeds to step 1308b.

If process 1300 determines that a virtual computing instance's behavior is a deviation from a security rule set, process 1300 proceeds to step 1307a. At step 1307a, process 1300 determines if the deviation warrants an action. If process 1300 determines that the deviation warrant an action, it proceeds to step 1308a. If process 1300 determines that the deviation does not warrant an action, it proceeds to step 1308b. This determination may be based on the severity of a threat that the deviation poses to a system (e.g., vehicle communications system 3). For example, if a virtual computing instance's behavior deviates from a security rule by deactivating an emulated airbag vehicle function of an ECU, such a deviation may warrant an action. On the other hand, if the virtual computing instance's behavior deviates from a security rule by deactivating an emulated radio vehicle function of an ECU, no action may be warranted.

At step 1308a, process 1300 executes a corrective action to prevent deviation of a virtual computing instance's operation. In some embodiments, this action may involve generating, deleting, or modifying a security rule (e.g. part of virtual computing instance rule set 620 and/or an associated rule set for a physical ECU or other device). In some embodiments, the action may involve reconfiguring software on a device within vehicle communications system 3, such as computer 100 or ECU 104. Moreover, in some embodiments, process 1300, at step 1308a, may also log the behavior, report the behavior, or send a warning, as discussed with respect to step 1308b below. Further, in some embodiments if the virtual instance itself is determined to be malicious or erroneous, the instance may be de-instantiated or spun down.

At step 1308b, process 1300 does not execute an action to prevent deviation of a virtual computing instance. In some embodiments, at step 1308b, rather than execute an action to prevent the deviation, process 1300 may log the behavior of the virtual computing instance in a log, report the behavior of the virtual computing instance (e.g., by sending a communication to database 302), and/or send a warning to a display (e.g., display 800), among other potential operations.

FIG. 14 shows an exemplary process 1400 for providing security to a vehicle or other IoT system based on testing a downloaded application in a virtual (e.g., quarantined or sandboxed) environment. In accordance with above embodiments, process 1400 may be implemented in vehicle communications system 7 depicted in FIG. 7, or in various other types of IoT networks. For example, process 1400 may be performed by a processor in a communications network of a vehicle (e.g., CPU 101 in vehicle communications system 7) or by an external device (e.g., an external server with a processor for operating a virtual environment). Such a processor may operate, for example, according to configuration 2. Regardless of the particular type of device performing process 1400, process 1400 may be performed using remote database 4, virtualization ID table 5, security rule program 6, in addition to elements of configuration 2 and/or vehicle communications system 3.

At step 1401, process 1400 identifies a request to download an external application to local memory, such as memory 102. This request may have been generated in response to a user interaction with infotainment system 8. In some embodiments, the external application may be initially stored at external server 702, and may be sent to vehicle communications system 7 based on a user request, such as a user interaction with infotainment system 8. For example, the external application may be a social media application selected for download by a user, a utility (e.g., map or compass application), an e-commerce application, or various other types of applications. In some embodiments the application may be selected through an interface of an infotainment system 8, while in other embodiments the application may be selected through a personal computing device (e.g., smartphone, tablet, etc.) of a user in communication with a vehicle or other IoT system.

At step 1402, process 1400 may store the external application in virtual environment memory (e.g., in virtualized environment memory 907). This memory may be read-only or otherwise configured to isolate its contents from potentially infecting a larger system, such as a computer 100 or vehicle communications system 7. For example, the memory 907 may be a sandboxed or quarantined environment in which code associated with the downloaded file(s) may not affect other code or files in the vehicle or IoT network.

At step 1403, process 1400 may instantiate a virtual network environment, or may access an already instantiated network environment, which may include any number of virtual computing instances 202. The number of virtual computing instances instantiated many vary depending on the nature of the external application downloaded or the implementation design. For example, in some embodiments, if the external application has a trusted signature, fewer virtual computing instances may be instantiated, as the application may require less testing. The number of virtual computing instances instantiated may also depend on a number of ECUs or vehicle functions implicated by code of the external application (e.g., an external application with code that will affect fewer ECUs and/or vehicle functions may require the instantiation of fewer virtual computing instances). In some embodiments, the virtual instances may be configured to mimic or replicate actual functioning ECUs in a vehicle network (e.g., having the same code and data as the operational ECUs), or another type of IoT network. In this manner, the downloaded file may be tested in an environment identical or similar to a genuine operational environment.

At step 1404, process 1400 may select a combination of virtual vehicle function settings or IoT system settings. In some embodiments, process 1400 may select these settings according to the application of virtual testing variables 1000, as discussed with respect to FIG. 10. In some embodiments, process 1400 may apply a security rule set (e.g., as discussed with respect to FIGS. 5, 6, and 13) with the combination of vehicle function settings, consistent with the disclosed embodiments.

At step 1405, process 1400 may apply a combination of virtual vehicle settings or IoT system settings to a virtual network environment. In some embodiments, process 1400 may apply these combinations according to the application of virtual testing variables 1000, as discussed with respect to FIG. 10 (e.g., to emulate current operating conditions of a vehicle or IoT system, or to apply predetermined combinations of controller settings).

At step 1406, process 1400 may execute the external application in the virtual or sandboxed memory environment. In some embodiments, executing the external application in the virtual memory environment may cause changes to virtual computing instances in the environment. For example, executing the external application may cause a virtual computing instance associated with a particular virtual controller (e.g., an ECU controlling an engine function or steering function) to send a signal to the particular virtual ECU to reverse its operational state (e.g., change from operating to idle or off).

At step 1407, process 1400 determines if more virtual environment testing is necessary. In some embodiments, this determination may be based on how a virtual computing instance behaves in the virtual network environment when the external application is executed. For example, a virtual computing instance may exhibit anomalous behavior within the virtual network environment when the external application is executed (e.g., the execution of the external application causes a virtual computing instance associated with steering to deactivate the steering function while a virtual computing instance associated with acceleration is active). In other situations, virtual computing instances may exhibit normal behavior (e.g., continue operating in the same state) when the external application is executed in the virtual network environment. In some embodiments, process 1400 may determine that more virtual environment testing is necessary based on the degree of anomalous behavior exhibited by the external application, a sensitivity of a controller, an importance or sensitivity of a controller function, and/or an input received at a user device. If process 1400 determines that more virtual environment testing is necessary, process 1400 may return to step 1404. If process 1400 determines that more virtual environment testing is not necessary, or if step 1407 is not performed, process 1400 may move to step 1408.

At step 1408, process 1400 may determine if the external application attempted to control a sensitive controller (e.g., a particular sensitive ECU in the virtual network environment). A sensitive ECU may be any ECU that controls a vehicle function closely related to the safety of a vehicle, driver, or passenger. In some embodiments, sensitive ECUs may be defined at a list contained at memory 102 or other storage medium, consistent with the disclosed embodiments. If process 1400 determines that the external application attempted to control a sensitive ECU, process 1400 may proceed to step 1409a. If process 1400 determines that the external application did not attempt to control a sensitive ECU, process 1400 may proceed to step 1409b.

At step 1409a, process 1400 may determine that the external application is unsafe. This determination may be based on the determination at step 1408 as to whether the external application attempted to control a sensitive ECU. In some embodiments, in place of or in addition to the determination at step 1408, process 1400 may analyze network traffic associated with the external application (e.g., packet inspection) to determine if the external application is unsafe. For example, if the external application attempted to send sensitive ECU information outside of vehicle communications system 7, it may be determined unsafe by process 1400. In some embodiments, process 1400 may determine that the external application is unsafe based on an error signature, which may have been generated based on an attempt to install and/or execute the external application within a virtual network environment.

In some embodiments, if the external application is determined to be unsafe, it may be deleted (i.e., removed from virtualized environment memory 907 and/or all parts of vehicle communications system 7). In some embodiments, process 1400 may also report the unsafe application to another computing device (e.g., database 302). In response to a report from process 1400, security rule program 6, rule table 403, process 1300, and/or related software may be changed (e.g., by database 302) in order to respond to a threat posed by the unsafe application. In this manner, an unsafe application determined with respect to one controller or one vehicle communications system 7 may be used to harden controllers and/or systems across multiple vehicles or other IoT systems.

At step 1409b, process 1400 may determine that the external application is safe. In some embodiments, if the external application is determined to be safe, it may be written to live environment memory 906, or other memory separate from virtualized environment memory 907. In some embodiments, if the external application is determined to be safe, it may also be permitted to execute within vehicle communications system 7, which may involve changing software on an ECU (e.g., ECU 105).

FIG. 15 shows an exemplary process 1500 for providing unique ECU keys to a vehicle based on unique CPU identifiers. In accordance with above embodiments, process 1500 may be implemented in vehicle communications system 11 depicted in FIG. 11. For example, process 1500 may be performed by a processor in a communications network of a vehicle (e.g., CPU 101 in vehicle communications system 11) or by an external device (e.g., an external server with a processor for operating a virtual environment). Such a processor may operate according to configuration 2. Additionally, process 1500 may be performed in non-automotive environments, such as various types of IoT environments as discussed above.

At step 1501, process 1500 may obtain a unique CPU value, which may be a CPU ID 1209, which may be unique to a particular ECU or other controller. The unique CPU value may be based on values within an EAX and/or CPUID register of CPU 1208. In other embodiments, the unique CPU value may be based on any or all of a physically unclonable function (PUF), areas of memory (e.g., memory 1206 or memory 103) having random values, or values of an oscillator or frequency existing in vehicle communications system 11. In some embodiments, the unique CPU value may be stored at memory 103 for processing in subsequent steps of process 1500 or other processes.

At step 1502, process 1500 may calculate a hash of the unique CPU value obtained at step 1501. The hash may be calculated by a computing device (e.g., computer 100) using a hash algorithm such as MD5, SHA1, SHA2, or CRC32. In some embodiments, the hash of the unique CPU value may be irreversible or unchangeable. In some embodiments, multiple CPU IDs may be used to generate a single key or multiple keys (e.g., such as a key for encrypting communications between the ECUs whose CPU IDs were used to generate the key).

At step 1503, the calculated hash value may be stored as a unique key in a cryptographic key table, which may include any number of unique keys created for ECUs or other devices. The cryptographic key table may be an instance of key table 1104. In some embodiments, the unique key may securely identify the controller to other controllers (e.g., a unique key for ECU 105 may uniquely identify that ECU to ECUs 106 and 107). In some embodiments, the unique key may allow the controller for which it was created to access key table 1104. Creating and storing unique keys in this manner may allow a system to avoid a provisioning step used by traditional systems, freeing up system resources for other purposes. Further, this technique may offer a highly unique and non-reproducible cryptographic key for purposes of accessing the key table, as described above.

FIG. 16 shows process 1600, a process for providing security to a vehicle based on testing a downloaded application in a virtual environment. In accordance with above embodiments, process 1600 may be implemented in vehicle communications system 11 depicted in FIG. 11, or in other types of IoT network environments. For example, process 1600 may be performed by a processor and/or other components in a communications network of a vehicle (CPU 101, memory 103, a bus, ECUs, etc.) or other IoT system.

At step 1601, process 1600 receives a power-on signal. This signal may be received at computer 100, an ECU (e.g., ECU 105), or other device within vehicle communications system 11. The power-on signal may be received based on a user starting vehicle communications system 11, accessing the vehicle, or performing another initiation operation.

At step 1602, a boot process may be initiated. In some embodiments, this boot process takes place at computer 100 and/or an ECU (e.g. ECU 105). Likewise, the boot process may be performed in non-automotive IoT environments.

At step 1603, a controller-specific key (e.g., a decryption key) may be retrieved from the cryptographic key table. This controller-specific key may have been created according to process 1500. In some embodiments, the controller-specific key may be retrieved by computer 100 from key table 104.

At step 1604, the controller-specific key may be sent to a controller. In some embodiments, this controller may be the controller for which the controller-specific key was generated (i.e., the controller whose CPU ID 1209 was used to create the key).

At step 1605, a controller receiving the controller-specific key may determine whether it may need access (e.g., during the session that will start when the boot process ends at step 1606b) to a cryptographic key table (e.g. key table 1104). In some embodiments, if the controller determines that it may need access to a cryptographic key table, it may also determine that it may need a copy of the controller-specific key, which may be the only key allowing it to access to key table 1104.

At step 1606a, the controller receiving the controller-specific key (i.e., the controller for which the key was created), may store it at a memory component of that controller as controller decryption key 1207 in memory 1206. In some embodiments, controller decryption key 1207 may persist in memory 1206 until the controller is powered down (i.e., when vehicle communications system 11 is turned off). In some embodiments, decryption key 1207 may only persist in memory 1206 for a set amount of time and/or until certain operations are completed (e.g., the ignition of a vehicle is started).

At step 1606b, the boot process may finish. In some embodiments, this boot process may be the boot process of a controller. The boot process of a controller may finish simultaneously or near simultaneously with the boot process of computer 100. In some embodiments, after the boot process finishes, a controller may be unable to access a decryption key needed to access key table 1104 (i.e. computer 100 may be prevented from sending controller-specific keys as it did at step 1604). In other embodiments, after the boot process finishes, a controller may be able to access a decryption key needed to access key table 1104 under a specific set of circumstances (e.g., the system of which the controller is a part, such as a vehicle, is in a particular operational state, the controller is in a particular operational state, a particular user input is received at the controller or a connected controller, etc.)

At step 1607, a controller may use the controller-specific key to access a cryptographic key table (e.g., key table 1104). In some embodiments, a controller may access the cryptographic key table in response to receiving encrypted communications. When accessing the cryptographic key table, a controller may obtain a cryptographic key that allows it to decrypt encrypted communications.

At step 1606b, the boot process finishes. In some embodiments, either as part of this step or substantially simultaneously with it, computer 100 may be prevented from sending controller-specific keys as it did at step 1604, such that a controller (e.g., any controller within vehicle communications system 11) is unable to obtain a decryption key, and is therefore unable to access the cryptographic key table (e.g., key table 1104).

While process 1600 is described within the context of a system boot, it should be noted that process 1600 or any combination of its steps may be performed outside of a system boot. In some embodiments, process 1600 may occur as part of a software initialization process. In this case, at step 1602 a software initialization process may be initiated rather than a boot process, and at step 1606b the software initialization process may finish, rather than a boot process.

FIG. 17 depicts an exemplary EAX register 1700, such as an EAX register that may exist within a CPU (e.g., CPU 1208). EAX register 1700 may have a register label 1702, which in this example identifies EAX register 1700 as an EAX register, rather than an ECX register or some other register. In other embodiments, register label 1702 may indicate that the register is a CPUID register or other similar register. EAX register 1700 may have any number of a bit 1704, which have been numbered sequentially from 0 to 31 in this exemplary depiction (e.g., reflecting a 32-bit register). A number of bits 1704 may be associated with a particular segment 1706 within EAX register 1700. For example, bits 4, 5, 6, and 7 may represent a segment 1706 designated for identifying the model number of the processor where EAX register resides. In some embodiments, a portion of the EAX register may be used to generate a unique CPU value, such as according to process 1500. In some embodiments, a CPUID register, which may also include bits 1704 and segments 1706, may be used to generate a unique CPU value.

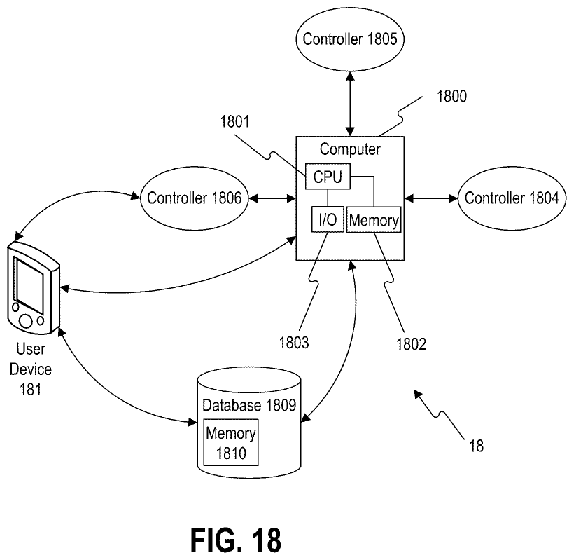

FIG. 18 depicts an exemplary controller system 18. Controller system 18 may include a user device 181, computer 1800, controllers 1804, 1805, and 1806, and database 1809. These devices may be connected to each other through a network (not shown), either local or wide area, such as any of the networks described with respect to FIG. 3. User device 181 may be a smartphone, tablet, smartwatch, smart clothing, laptop, desktop computer, telephone, IoT device, or other device capable of data processing and network communications. Computer 1800 may include any number of a CPU 1801, memory 1802, and an input/output interface (I/O) 1803. Database 1809 may include memory 1810. These may be instances or variations of similarly named components in FIG. 3. In some embodiments, computer 1800, user device 181, and/or database 1809 may be associated with a security provider. In some embodiments, computer 1800, user device 181, and/or database 1809 may carry out any portion of processes 1300, 1400, 1500, 1600, and/or 1900, consistent with the disclosed embodiments.

In some embodiments, computer 1800 may request access to a device database 1809 and/or a controller (e.g., controller 1804). For example, in some embodiments, such as within a software build environment (e.g., Apache-based, Bazel, MSBuild, SCons, etc.), computer 1800 may attempt to access database 1809 and/or a controller (e.g., controller 1804). Computer 1800 may attempt to access any of these devices in order to send data, receive data, modify code, install a program, and/or perform any operations relevant to software maintenance or security. In some embodiments, devices within controller system 18 may carry out process 1900, such as to protect against unauthorized access of devices within the system (e.g., controllers 1804-1806).

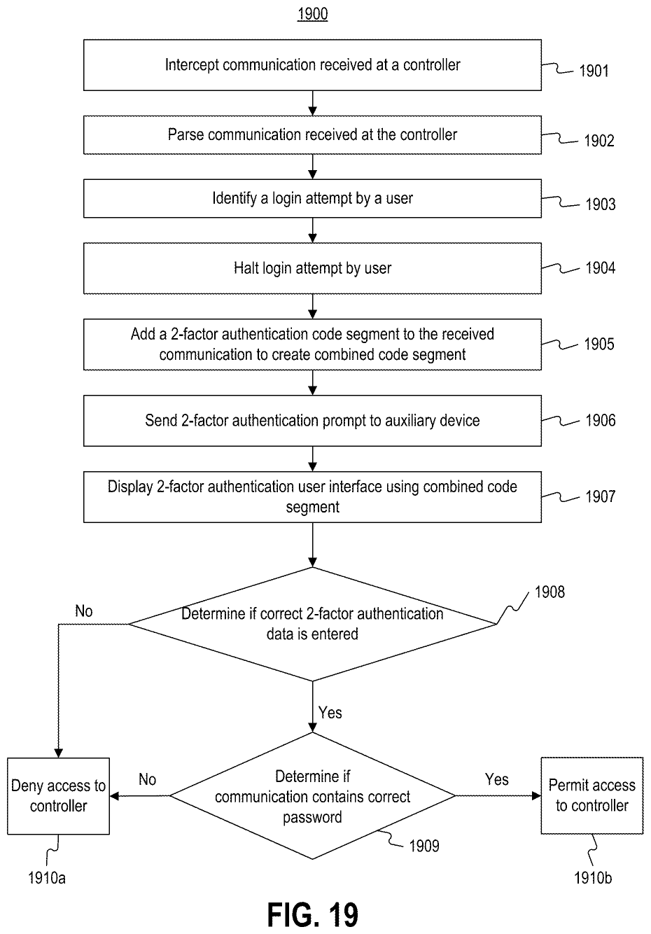

FIG. 19 illustrates process 1900, a process for protecting a controller system from unauthorized operations. In accordance with above embodiments, process 1900 may be implemented in controller system 18 depicted in FIG. 18, or in other types of IoT network environments. For example, process 1900 may be performed by a processor and/or other components in a communications network of a vehicle or other IoT system (CPU 101, memory 103, a bus, controllers, etc.).

At step 1901, process 1900 may include intercepting a communication received at a controller (e.g., controller 1804), which may include a number of data packets. In some embodiments, this communication may be sent from another device within a controller system 18, including another controller (e.g., controller 1805). In some embodiments, the communication received at a controller may comprise a software update, a software patch, a network request, or an authentication request. For example, the communication may be configured to read data on the controller (e.g., data on a memory component of the controller), write data to the controller (e.g., to a memory component of the controller, such as to install a program or a software update), halt operations on the controller, reconfigure the controller, and/or activate or deactivate power to the controller. In some instances, a controller may request a log-in from a device that sent the communication prior to other operations proceeding on the controller. In some embodiments, the communication may comprise code for executing an instruction at the controller.

At step 1902, process 1900 may parse the communication received at the controller. Parsing the communication may include separating the received communication into segments (such as based on headers in the communication), eliminating portions of redundant code, compressing a portion of the communication, and/or extracting portions of the received communication to be used for a specific purpose (e.g., further analysis). Different portions of the received communication may correspond to different operations to be carried out on the controller. For example, process 1900 may extract a portion of the received communication that corresponds to a login attempt by a user to the controller, which may include information such as a user identifier (e.g., an identifier associated with a user of a device that sent the received code), a device identifier (e.g., an identifier associated with a device that sent the received code), a signed key, a password, or other information designed to identify and/or authenticate the source and/or safety of the received communication.

Process 1900 may parse the received communication at a code level and/or at a packet level (e.g., using deep-packet inspection, inspection of packet headers, etc.). In some embodiments, process 1900 may perform dynamic deep-packet inspection on a payload of a packet according to a set of rules to minimize computing resource usage associated with deep-packet inspection. Further, process 1900 may only inspect certain portions of a packet (e.g., header fields) and/or only certain packets based on an identified source of a packet, a format of a packet, a type of data communication associated with the packet, a key, a signature, and/or a parsed portion of a packet (e.g., an identified sequence of code).

In some embodiments, process 1900 may determine a risk level associated with any number of portions of the received communication. For example, process 1900 may identify a code sequence of the received communication that is configured to stop power to the controller, or cause a buffer overflow event, etc., and may determine that the portion presents a high level of risk. In some embodiments, if process 1900 determines that the received communication does not reach a defined threshold of risk, process 1900 may proceed to step 1910b directly from step 1902. In some embodiments, if process 1900 determines that the received communication does reach a particular threshold of risk, process 1900 may proceed to step 1903. In some embodiments, if the risk level associated with a portion of the received communication surpasses a threshold level of risk (which may be higher than the threshold level of risk process 1900 uses to determine whether to proceed to step 1903), process 1900 may stop processing the received communication and take a responsive action (e.g., delete stored segments of the received communication, send a notification to a remote device associated with providing security to a receiving device, send a message to a device that sent the received communication, blacklist the sending device, etc.).

At step 1903, process 1900 may identify a login attempt by a user (e.g., computer 1800). In some embodiments, process 1900 may identify the login attempt by locating a header within the received communication that indicates a login attempt. In some embodiments, process 1900 may identify the login attempt by identifying a particular sequence of code within the received communication. Further, login attempts may be identified based on properties of GUI elements (e.g., Microsoft UI Automation™ properties, etc.).

At step 1904, process 1900 may in some embodiments halt the login attempt. In some embodiments, halting the login attempt may include storing the received communication in a particular memory component or partition until another step in process 1900 is reached. Further, halting the login attempt may include generating a user interface element (e.g., indicating the halting, or a rejection of the login). In some embodiments, even if the login attempt is halted, process 1900 may still permit other portions of code to be received at the controller (e.g., process 1900 may permit installation of software associated with the login request to be installed to a safe location in memory while process 1900 moves to other steps).

At step 1905, process 1900 may add a two-factor authentication code segment to the received communication to create a combined or composite code segment. The combined code segment may include code configured to send a prompt to another device (e.g., computer 1800), render the received communication inoperable, or otherwise prevent the received communication from affecting the controller until step 1910b is reached. In some embodiments, the two-factor authentication code may be inserted into the received communication (e.g., between two different portions of the communication parsed at step 1902). In other embodiments, the two-factor authentication code may be appended to the end of the received communication. In some embodiments, the two-factor authentication code may be kept completely separate from the received communication.

At step 1906, process 1900 sends a two-factor authentication prompt to an auxiliary device (e.g., a user device 181 that sent the received communication to the controller). The two-factor authentication prompt may be part of or separate from the combined code segment created at step 1905. In some embodiments, the two-factor authentication prompt may be configured to cause a user device (e.g., a user device 181) to display a graphical user interface at a user device (e.g., discussed with respect to step 1907). In some embodiments, process 1900 sends the two-factor authentication prompt to a user device (e.g., a user device 181) associated with the device that sent the received communication (e.g., a computer 1800). Such an association may be indicated by data stored in memory 1810, memory of a controller (e.g., controller 1804), or another device within controller system 18. For example, memory 1810 may contain information that indicates a particular auxiliary device (e.g., user device 181) is designated to receive the two-factor authentication prompt for login attempts related to a particular device (e.g., computer 1800). In some embodiments, these associations may be encrypted (e.g. according to aspects of process 1500).

At step 1907, process 1900 displays a two-factor authentication interface. In some embodiments, this interface may be displayed using the combined code segment created at step 1905. In some embodiments, the interface may include a notice indicating to a viewer that a device (e.g., computer 1800) has attempted to log in to a controller. In some embodiments, the two-factor authentication interface may be displayed at a user device 181. The interface may allow for a user to input a two-factor authentication code (e.g., a combination of alphanumeric characters, a swipe pattern on a touchscreen display, a voiceprint recording, a fingerprint scan, etc.). In some embodiments, the interface may also include information relating to the login attempt, such as the controller at which the login attempt was made, a source of the login attempt (e.g., information identifying a computer 1800 such as an IP address, MAC address, model number, or other identifying information), a time at which the login attempt was made (e.g., when the received communication was sent or received), operations implicated by the code (e.g., the received communication is configured to install a program on the controller, access sensitive memory addresses of the controller, etc.), and/or a risk level associated with operations implicated by the code. Any or all of this information may have been determined when the received communication was parsed at step 1902.

At step 1908, process 1900 may determine if correct two-factor authentication data is entered. In some embodiments, to make this determination, process 1900 may examine a two-factor authentication code entered at a device (e.g., a user device 181) attempting to log in to a controller and compare it to an expected two-factor authentication code. If the two-factor authentication code entered at a device matches the expected two-factor authentication code (e.g., a two-factor authentication code stored in memory of a computer 1800 carrying out process 1900), then process 1900 may determine that that the entered two-factor authentication code is correct. If process 1900 determines that the correct two-factor authentication data has not been entered (e.g., at a user device 181), process 1900 may move to step 1910a to deny access to the controller (e.g., deny execution of code on the controller, deny access to an I/O interface of the controller, etc.). In some embodiments, if process 1900 determines that the correct two-factor authentication data has not been entered, process 1900 may move to step 1904 to permit another login attempt.

At step 1909, process 1900 may determine if the received communication contains a correct password. If process 1900 determines that the received code contains an incorrect password, process 1900 may move to step 1910a. If process 1900 determines that the received communication contains a correct password, it may move to step 1910b and permit access to the controller.

At step 1910a, process 1900 denies access to the controller (i.e., the controller at which the communication was received). In some embodiments, when process 1900 denies access to the controller, it may send a warning to another device (e.g., another computer 1800, which may be associated with providing security to a number of controllers in controller system 18). Such a warning may also include information about the communication, such as the information described in steps 1902 and 1907. In some embodiments, the warning may be sent to a display connected to the controller (e.g., an infotainment display connected to a controller in a vehicle). In some embodiments, either in addition to or instead of sending a warning, process 1900 may store information about the communication in a log (e.g., memory 1810). In some embodiments, process 1900 may add the source of the communication to a blacklist, such as if the source has attempted to unsuccessfully access the controller a threshold number of times.

At step 1910b, process 1900 permits access to the controller (i.e., the controller at which the communication was received). In some embodiments, at step 1910b, process 1900 may automatically process a portion or the entirety of the communication received at step 1901.

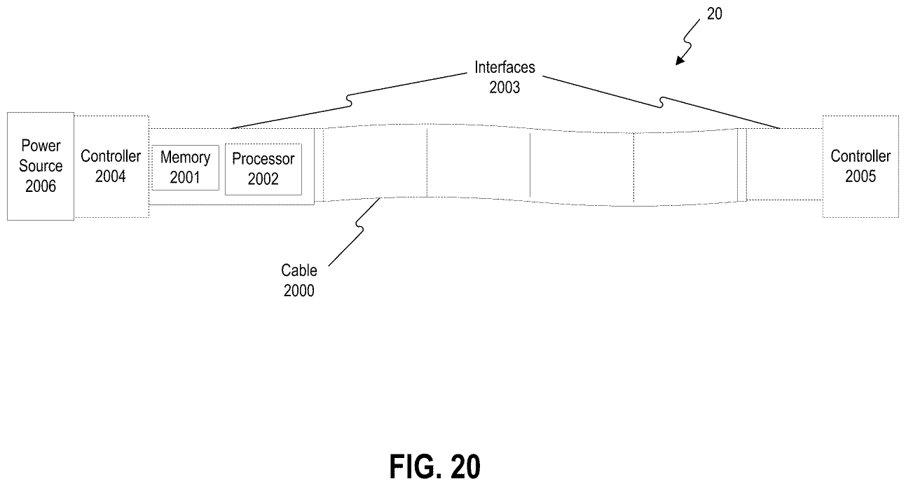

FIG. 20 depicts an exemplary smart cable 20. Smart cable 20 may include a cable 2000, which may connect separate devices, such as controller 2004 and controller 2005. However, controllers 2004 and 2005 are merely exemplary, and cable 2000 may connect any number of different devices, including a computer (e.g., computer 100), a controller, an IoT device, a smartphone, a tablet, a special purpose computer, an infotainment center, a database, a USB drive, or any other device configured to send or receive data. Accordingly, cable 2000 may take various different forms, such as an automotive CAN bus cable, Local Interconnect Network (LIN) cable, ethernet (e.g., CAT-5) cable, coaxial cable, USB cable, Firewire cable, fiber optic cable, etc.

In some embodiments, cable 2000 may include a physical interface 2003 at an end of the cable, which may be configured to mechanically, magnetically, or otherwise connect to a particular device, such as via an interface port of a controller, smartphone, etc. (e.g., an electromechanical or fiber optic interface). Interface 2003 may be permanent or impermanently affixed to cable 2000. In other embodiments, an interface 2003 may be affixed to part of a larger system (e.g., a wiring harness for a controller area network in a vehicle or IoT system), for which a cable 2000 may carry traffic among and between multiple connected devices. Interface 2003 and cable 2000 itself may comprise a physically protective housing (made of any combination of hard plastic, metal, glass, composites, etc.), as well as a signal protective housing (e.g., copper shield, insulator, or other interference-reducing material). In some embodiments, interface 2003 may have an openable portion (e.g., a door, cover, or latch, etc.) that allows a person to access components within the interface, such as to replace faulty or outdated components.

While cable 2000 is depicted having two ends, this is merely exemplary, as cable 2000 may have any number of ends. For example, while in some embodiments cable 2000 may predominantly connect two devices or systems, in other embodiments it may also fork or splice into multiple endpoints (e.g., with each an endpoint connecting to a different controller, but with communications to or from those controllers being sent across the same cable 2000), with each endpoint possibly having its own interface 2003. In further embodiments, cable 2000 may have several different discrete signal conductors (e.g., in a CAT-5 cable), each carrying different signals. Further, cable 2000 may also multiplex signals across common conductors.

Cable 2000 may be made using a number of designs and materials. In some embodiments, cable 2000 may be made predominantly of an electrically conductive material (e.g., a conductive metal), conductive for transmitting electronic representations of data communications. In other embodiments, cable 2000 may be a signal conductor conductive for transmitting optical representations of data communications (e.g., glass or plastic). In some embodiments, cable 2000 may include portions of fiber optic cable and portions of conductive material, which may run through the cable in parallel (e.g., a fiber optic portion may carry data, and a conductive material portion may carry power). In some embodiments, cable 2000 may comprise multiple layers of conductors and/or insulators (e.g., a coaxial cable). Cable 2000 may also include any number of protective sheaths (e.g., an outer layer of plastic to prevent against wear and/or signal interference). In some embodiments, some or all of cable 2000 may flex, to allow it to bend around potential obstacles and/or be placed in areas with convoluted geometries (e.g., the frame of an automobile). Portions of cable 2000 and/or interface 2003 may have different degrees of flexibility. For example, in some embodiments, cable 2000 may contain no components other than wiring, and may have high flexibility, whereas interface 2003 may contain components for processing data and may be semi-rigid to protect the components from damage due to bending.

In some embodiments, smart cable 20 may draw power from a device to which it also routes data communications (e.g., controller 2004 having a power supply). In other embodiments, smart cable 20 may be connected to separate power source 2006 (e.g., power over ethernet, power over coaxial, power over USB, etc.), which may supply some or all of the power consumed by smart cable 20 for purposes of the operations of controllers 2004 and 2006. In other embodiments, power source 2006 may be integrated into cable 2000 or an interface 2003. Power source 2006 may be a battery (e.g., a battery in a vehicle) or multiple batteries (e.g., grid energy storage). In some embodiments, power source 2006 may only power a portion of smart cable 20. Power source 2006 may also include a switch, which may allow a person to selectively choose whether to permit power source 2006 to power smart cable 20 or a portion of smart cable 20. For example, cable 2000 may draw power from an endpoint (e.g., controller 2004), but processor 2002 and/or memory 2003 (and/or other components of smart cable 20 may draw power from power source 2006. In this exemplary embodiment, cable 2000 may transmit data communications unimpeded (e.g., unprocessed, such as according to steps of process 2100) even if power to certain components of smart cable 20 is turned off.

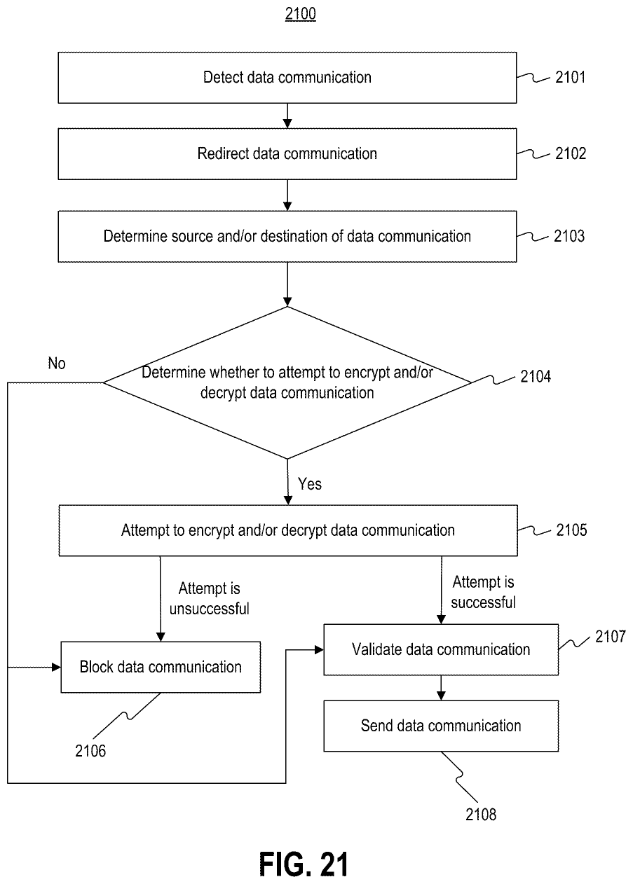

Smart cable 20 may include components for sending, receiving, detecting, intercepting, and/or altering (e.g., encrypting and/or decrypting, rerouting, blocking, etc.) data communications sent through the cable. For example, in some embodiments, smart cable 20 may have a number of processors 2002 and memories 2001, either or both of which may be part of a connector interface (e.g., interface 2003). In some embodiments, a processor 2002 may process data communications according to information stored in memory 2001 (e.g., rules, keys, signatures, configurations, settings, etc.). For example, memory 2001 may contain a number of encryption keys, decryption keys, device identifiers, and/or associations between device identifiers and an encryption and/or decryption key. In some embodiments, smart cable 20 may be configured to send data communications to a processor 2002 for examination (and possible alteration) before sending to a destination device. For example, a processor 2002 may process data communications according to process 2100, described with respect to FIG. 21. In some embodiments, such as when smart cable 20 comprises fiber optic portions, smart cable 20 may include, at an interface 2003 or elsewhere, a fiber optic illuminator, a transmitter, an optical regenerator, an optical receiver, and/or a sensor. Smart cable 20 may carry out any portion of processes 1300, 1400, 1500, 1600, and/or 1900, consistent with the disclosed embodiments.

FIG. 21 illustrates exemplary process 2100, a process for protecting data communications between devices. In accordance with above embodiments, process 2100 may be implemented using a smart cable 20 depicted in FIG. 20, which in some embodiments may be deployed in vehicle system (e.g., vehicle communications system 1) or in other types of IoT network environments. For example, process 2100 may be performed by a processor and/or other components in a communications network of a vehicle (CPU 101, memory 103, a bus, ECUs, etc.) or other IoT system.

At step 2101, process 2100 may detect a data communication. In some embodiments, a data communication may be detected at a point along smart cable 20 (e.g., initially at a receiving interface 2003 or later at an egress interface 2003). A data communication may be detected by an application, agent, or code stored in memory 2001 and running by processor 2002, which may be part of cable 20. For example, the application, agent, or code may be configured to detect and analyze some or all incoming communications (e.g., packets and other communications). The analysis may include parsing header fields of the communications, sender address or identity information, payload contents, data size attributes, timing attributes, or other attributes.

At step 2102, process 2100 may redirect or temporarily quarantine the data communication. In some embodiments, the data communication may be forwarded to a component (e.g., processor 2002), for processing (e.g., performing a step of process 2100 on the data communication).

At step 2103, process 2100 may determine a source and/or destination of the data communication. In some embodiments, a source and destination of the data communication may be similar types of devices (e.g., both devices are controllers). In other embodiments, a source and destination of the data communication may be different types of devices (e.g., a computer sending a data communication to a controller). At step 2103, process 2100 may determine a source or destination of a data communication based on information contained in the data communication. For example, the data communication may contain information such as an IP address, MAC address, packet segment, a message type, a key, a signature, etc., which may identify a particular device (e.g., controller 2004), which may be a source or destination of the data communication. In some embodiments, process 2100 may use this information to access related information. For example, process 2100 may determine a device identifier in memory 2001 corresponding to information identifying a particular device in the data communication. In some embodiments, process 2100 may identify an encryption or decryption key suitable for the data communication based on a determined device identifier and/or information contained in the data communication.

At step 2104, process 2100 may determine whether to attempt to encrypt and/or decrypt the data communication. In some embodiments, process 2100 may determine to attempt to encrypt and/or decrypt the data communication if it can determine a suitable key for encryption or decryption. In some embodiments, process 2100 may only determine to encrypt data communications of a certain type (e.g., a sensitive communication). For example, if the data communication is a ping (e.g., to test the reachability or availability of a host), it may be considered non-sensitive and process 2100 may determine to not to attempt to encrypt it. In some embodiments, process 2100 may determine to attempt to encrypt outgoing data communications and attempt to decrypt incoming data communications. If process 2100 determines to attempt to encrypt or decrypt the data communication, it may proceed to step 2105. If process 2100 determines to not to attempt to encrypt or decrypt the data communication, it may proceed to either step 2106 or step 2107. For example, if process 2100 determines not to attempt to encrypt a data communication because it is determined not to be a sensitive communication, or determines not to attempt to decrypt a data communication because it does not appear suspicious, it may proceed to step 2107 (i.e., bypassing step 2105). In other embodiments, if process 2100 determines not to attempt to decrypt the data communication because it appears suspicious, it may proceed to step 2106 (i.e., bypassing step 2105).

At step 2105, process 2100 may attempt to encrypt and/or decrypt the data communication. In some embodiments, process 2100 may attempt to encrypt or decrypt a data communication based on a suitable cryptographic key or other information determined at step 2103. For example, if process 2100 determines that the data communication redirected at step 2102 has a particular source (e.g., is sent from a particular controller), and process 2100 determined a suitable encryption key for the data communication at step 2103, process 2100 may attempt to encrypt the data communication according to that key.

At step 2106, process 2100 may block the data communication. In some embodiments, process 2100 may block the data communication based on an unsuccessful attempt at decrypting it. In some embodiments, process 2100 may take other actions in addition to blocking the data communication, such as saving trace information from the data communication to memory, sending a prompt to another device (e.g., a computer, infotainment display, etc.), and/or adding information associated with a source of the data communication to a blacklist.

At step 2107, process 2100 may validate the data communication. In some embodiments, process 2100 may validate the communication by examining a signature of the data communication to determine if it corresponds to a signature expected based on the source of the data communication. In some embodiments, an expected signature for the source may be stored in memory (e.g., memory 2001). In some embodiments, process 2100 may validate a data communication using a checksum or computed hash.

At step 2108, process 2100 may send a data communication. In some embodiments, process 2100 may send a data communication after having decrypted, encrypted, and/or validated it. The data communication may be sent to an intended destination device (e.g., a controller specified by routing information or the like contained in the data communication). In some embodiments, process 2100 may send the data communication to a destination other than an intended destination. For example, process 2100 may send the data communication to a device unconnected to a smart cable 20 (e.g., an external server 702).

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

For example, while some embodiments are discussed in a context involving electronic controller units (ECUs) and vehicles, these elements need not be present in each embodiment. While vehicle communications systems are discussed in some embodiments, other electronic systems (e.g., IoT systems) having any kind of controllers may also operate within the disclosed embodiments. Such variations are fully within the scope and spirit of the described embodiments.

The disclosed embodiments may be implemented in a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials will be developed and the scope of the these terms is intended to include all such new technologies a priori.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. . A virtualized system for protecting a plurality of controllers within a controller system, the virtualized system comprising:
at least one hardware processor configured to emulate the plurality of controllers; and
a set of instructions executable by the at least one hardware processor to perform operations including:
instantiating at least one virtual computing instance;
identifying; a corresponding set of security rules configured to maintain security of the at least one virtual computing instance, wherein the set of security rules is associated with the at least one virtual computing instance based on attributes of the at least one virtual computing instance; and
monitoring behavior of the at least one virtual computing instance for a deviation from the set of security rules.

2-20. (canceled)
